(19) United States
(12) Patent Application Publication
(10) Pub. No.: US 2023/0178781 A1
(43) Pub. Date: Jun. 8, 2023

(54) ALKALINE MEMBRANE FUEL CELL ASSEMBLY COMPRISING A THIN MEMBRANE AND METHOD OF MAKING SAME

(71) Applicant: HYDROLITE LTD, Caesarea (IL)

(72) Inventors: Charly David Azra, Harish (IL); Miles Page, Hod Hasharon (IL); Ervin Tal-Gutelmacher, Hod Hasharon (IL)

(73) Assignee: HYDROLITE LTD, Caesarea (IL)

(21) Appl. No.: 18/103,536

(22) Filed: Jan. 31, 2023

Related U.S. Application Data
(63) Continuation-in-part of application No. 16/973,820, filed on Dec. 10, 2020, now Pat. No. 11,600,827.
Application No. 16/973,820 is a continuation-in-part of application No. 17/830,424, filed on Jun. 2, 2022.
Application No. 17/830,424 is a continuation-in-part of application No. PCT/IL2022/050590, filed on Jun. 2, 2022.
Application No. PCT/IL2022/050590 is a continuation-in-part of application No. PCT/IL2021/051524, filed on Dec. 22, 2021.
Application No. PCT/IL2021/051524 is a continuation-in-part of application No. PCT/IL2022/050091, filed on Jan. 20, 2022.
(60) Provisional application No. 63/211,186, filed on Jun. 16, 2021.
(60) Provisional application No. 63/221,035, filed on Jul. 13, 2021.
(60) Provisional application No. 63/221,035, filed on Jul. 13, 2021.
(60) Provisional application No. 63/140,889, filed on Jan. 24, 2021.
(60) Provisional application No. 63/139,842, filed on Jan. 21, 2021.
(60) Provisional application No. 63/211,186, filed on Jun. 16, 2021.
(60) Provisional application No. 63/221,035, filed on Jul. 13, 2021.

(51) Int. Cl. H01M 8/1004; H01M 8/0273

(52) U.S. Cl. CPC H01M 8/1004; H01M 8/0273; H01M 2008/1095

(57) ABSTRACT

Membrane electrode assemblies (MEA) and electrochemical devices such as fuel cells, electrolyzers and reversible devices are provided. The MEA comprises gas diffusion electrodes (GDEs) comprising respective gas diffusion layers (GDLs) coated with respective catalyst layers, and a thin membrane coated on either or both catalyst layers and having a total thickness of at most 30 microns. The GDEs are joined together to form the MEA with the thin membrane located between the catalyst layers, and the MEA is sealed and stacked to be operable in the electrochemical devices. Advantageously, using the GDEs to deposit the membrane enable forming very thin and efficient membranes.

### CROSS REFERENCE TO RELATED APPLICATIONS

This application is a Continuation-In-Part of U.S. patent application Ser. No. 16/973,820, filed on Dec. 10, 2020, which is a National Phase Application of PCT International Application No. PCT/IL2019/050607, International Filing Date May 28, 2019, entitled: “ALKALINE MEMBRANE FUEL CELL ASSEMBLY COMPRISING A THIN MEMBRANE AND METHOD OF MAKING SAME”, published on Dec. 19, 2019, under PCT International Application Publication No. WO 2019/239399, which claims the priority of Israel Patent Application No. 259978, filed on Jun. 12, 2018, which is hereby incorporated by reference in its entirety.

This application is also a Continuation-In-Part of U.S. patent application Ser. No. 17/830,424 and of WIPO Application No. PCT/IL2022/050590, both filed on Jun. 2, 2022 and both claiming priority from U.S. Provisional Application No. 63/211,186, filed on Jun. 16, 2021, and from U.S. Provisional Application No. 63/221,035, filed on Jul. 13, 2021—which are incorporated herein by reference in their entirety.

This application is also a Continuation-In-Part of WIPO Application No. PCT/IL2021/051524 filed on Dec. 22, 2021, which claims priority from U.S. Provisional Application No. 63/140,889, filed on Jan. 24, 2021, which are incorporated herein by reference in their entirety.

This application is also a Continuation-In-Part of WIPO Application No. PCT/IL2022/050091 filed on Jan. 20, 2022, which claims priority from U.S. Provisional Applications Nos. 63/139,842, filed on Jan. 21, 2021, 63/211,186, filed on Jun. 16, 2021 and 63/221,035, filed on Jul. 13, 2021, which are incorporated herein by reference in their entirety.

### BACKGROUND OF THE INVENTION

### 1. Technical Field

The present invention relates to the field of electrochemical devices, and more particularly, to preparing membrane electrode assemblies (MEAs).

### 2. Discussion of Related Art

Electrolyzers and fuel cells are electrochemical devices that produce hydrogen and consume hydrogen to produce energy, respectively, which gain uses as alternative energy sources (fuel cells) and fuel sources (electrolyzers). Combined configurations provide independent sustainable energy sources that can regenerate their hydrogen supply.

U.S. Pat. No. 6,946,210, which is incorporated herein by reference in its entirety, teaches electrochemical polymer electrolyte membrane cell stacks that includes one or more individual fuel cell cassettes, each fuel cell cassette having at least one membrane electrode assembly, fuel flow field and oxidant flow field. Within each fuel cell cassette, each membrane electrode assembly has at least one manifold opening for the passage of reactant manifolds through the cassette, all of which are bonded about the perimeter by a sealant, and each flow field has at least one manifold opening and any manifold openings on the flow fields which do not correspond to a manifold providing reactant for distribution to such flow field is bonded about its perimeter by a sealant. Each fuel cell cassette may also contain other typical components of an electrochemical polymer electrolyte membrane cell stack, such as separator plates or coolant flow fields, which also have manifold openings which may or may not be bonded about the perimeter. The membrane electrode assembly, flow fields, and other components are encapsulated along the peripheral edges by a resin such that the entire periphery of the fuel cell cassette is encapsulated by the resin.

U.S. Patent Application Publication Nos. 20110300466 and 20130273453, which are incorporated herein by reference in their entirety, teach an alkaline membrane fuel cell including at least one of a catalyst coated OH-ion conducting membrane having a catalyst layer and an OH-ion conducting membrane, and a catalyst coated carbonate ion conducting membrane having a catalyst layer and optionally a carbonate ion conducting membrane, respectively, wherein the at least one catalyst layer is chemically bonded to a surface of the at least one membrane, wherein the chemical bonding is established by crosslinking of polymer constituents across an interface between the catalyst layer(s) and the membrane(s).

U.S. Patent Application Publication No. 20130146471, which is incorporated herein by reference in its entirety, teaches a membrane-electrode assembly for use in a reversible fuel cell comprises an ion conductive membrane having first and second surfaces; a first electrocatalyst layer in contact with the first surface of the membrane, such first electrocatalyst layer comprising at least one discrete electrolysis-active area and at least one discrete energy generation-active area. A second electrocatalyst layer is placed in contact with the second surface of the membrane, such second electrocatalyst layer comprising at least one discrete electrolysis-active area and at least one discrete energy generation-active area. Each of the discrete electrolysis-active area(s) on the first electrocatalyst layer correspond and are aligned with each of the discrete electrolysis-active area(s) on the second electrocatalyst layer, and each of the discrete energy generation-active area(s) on the first electrocatalyst layer correspond and are aligned with each of the discrete energy generation-active area(s) on the second electrocatalyst layer.

### SUMMARY OF THE INVENTION

The following is a simplified summary providing an initial understanding of the invention. The summary does not necessarily identify key elements nor limit the scope of the invention, but merely serves as an introduction to the following description.

One aspect of the present invention provides a membrane electrode assembly (MEA) for an electrochemical device, the MEA comprising: a first gas diffusion electrode (GDE) comprising a first gas diffusion layer (GDL) coated with a first catalyst layer, a second GDE comprising a second GDL coated with a second catalyst layer, a thin membrane coated on the first catalyst layer of the first GDE and/or on the second catalyst layer of the second GDE, wherein a total thickness of the thin membrane is at most 30 microns, wherein the first and the second GDEs are joined together to form the MEA with the thin membrane located between the first and the second catalyst layers, and a seal configured to seal the MEA.

One aspect of the present invention provides fuel cells and/or electrolyzer comprising stacks of disclosed MEAs.

One aspect of the present invention provides a reversible device comprising the stack of the MEAs, the reversible device configured to operate alternately as a fuel cell in a fuel cell mode and as an electrolyzer in an electrolyzer mode, wherein the hydrogen-side catalyst layer of the MEAs is configured to catalyze hydrogen oxidation in the fuel cell mode and to catalyze hydrogen formation in the electrolyzer mode, and the oxidant-side catalyst layer of the MEAs is configured to catalyze oxygen reduction in the fuel cell mode and to catalyze oxygen formation in the electrolyzer mode.

One aspect of the present invention provides a self-refueling power-generating system comprising: the reversible device, a controller configured to determine operation of the reversible device in the fuel cell mode or in the electrolyzer mode, a hydrogen unit configured to supply hydrogen to the reversible device when operated in the fuel cell mode, and receive and optionally compress hydrogen from the reversible device when operated in the electrolyzer mode, an oxidant unit configured to supply oxygen to the reversible device when operated in the fuel cell mode, and receive and optionally compress oxygen from the reversible device when operated in the electrolyzer mode, a water unit configured to supply water or dilute electrolyte to the reversible device in a closed circuit and in conjunction with the supply of oxygen thereto, wherein the water unit comprises a gas/liquid separation module configured to deliver separated oxygen from the reversible device to the oxidant unit, and a power connection configured to receive power from the reversible device when operated in the fuel cell mode, and deliver power to the reversible device when operated in the electrolyzer mode, wherein the power connection is configured to deliver the received power to an external load when required, and to receive power for delivery from an external source when available.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout. In the accompanying drawings:

FIG. 1 is a high-level schematic illustration of preparing and using membrane electrode assemblies (MEAs) with thin membranes for electrochemical devices, according to some embodiments of the invention.

FIGS. 2A, 2B, 3A and 3B are high-level schematic illustrations of kits for forming membrane assemblies 100, according to some embodiments of the invention.

FIGS. 4A, 4B and 4C are high-level schematic illustrations of sealed assemblies, according to some embodiments of the invention.

FIG. 5 is a high-level schematic flowchart of methods of making membrane assemblies, according to some embodiments of the invention.

FIGS. 6A, 6B and 6C provide non-limiting examples for membrane assemblies, according to some embodiments of the invention.

FIG. 7 is a high-level schematic illustration of a self-refueling power-generating system with reversible devices, according to some embodiments of the invention.

FIG. 8 is a high-level flowchart illustrating methods of configuring a power-generating system to be self-refueling and self-sustaining, according to some embodiments of the invention.

FIG. 9 is a high-level schematic illustration of the operation of AEM and PEM reversible devices in fuel cell mode and in electrolyzer mode, according to some embodiments of the invention.

FIG. 10A is a high-level schematic block diagram of an electrolyzer, according to some embodiments of the invention.

FIG. 10B is a high-level schematic block diagram of a fuel cell, according to some embodiments of the invention.

FIG. 10C is a high-level schematic block diagram of a dual cell, according to some embodiments of the invention.

FIG. 11 is a high-level flowchart illustrating methods, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention may be practiced without the specific details presented herein. Furthermore, well known features may have been omitted or simplified in order not to obscure the present invention. With specific reference to the drawings, it is stressed that the particulars shown are by way of example and for purposes of illustrative discussion of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein are for the purpose of description and should not be regarded as limiting.

Embodiments of the present invention provide efficient and economical methods and mechanisms for preparing membrane electrode assemblies (MEAs) and thereby provide improvements to the technological field of electrochemical devices. MEAs and electrochemical devices such as fuel cells, electrolyzers and reversible devices are provided. The MEA comprises gas diffusion electrodes (GDEs) comprising respective gas diffusion layers (GDLs) coated with respective catalyst layers, and a thin membrane coated on either or both catalyst layers and having a total thickness of at most 30 microns. The GDEs are joined together to form the MEA with the thin membrane located between the catalyst layers, and the MEA is sealed and stacked to be operable in the electrochemical devices. Advantageously, using the GDEs to deposit the membrane enable forming very thin and efficient membranes.

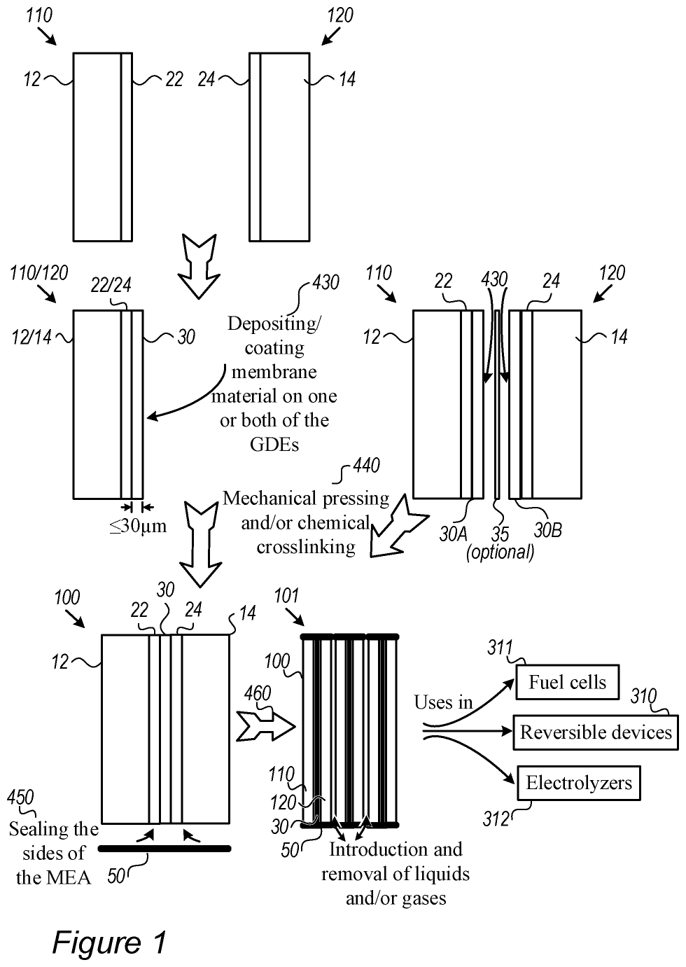

FIG. 1 is a high-level schematic illustration of preparing and using membrane electrode assemblies (MEAs) with thin membranes for electrochemical devices, according to some embodiments of the invention. Certain embodiments comprise a membrane electrode assembly (MEA) 100 for an electrochemical device 101, the MEA comprising a first gas diffusion electrode (GDE) 110 comprising a first gas diffusion layer (GDL) 12 coated with a first catalyst layer 22, a second GDE 120 comprising a second GDL 14 coated with a second catalyst layer 24, a thin membrane 30 coated on first catalyst layer 12 of first GDE 110 and/or on second catalyst layer 24 of second GDE 120 (indicated schematically as step 430), wherein a total thickness of thin membrane 30 is at most 30 microns. MEA 100 is formed by joining together first and second GDEs 110, 120 with thin membrane 30 located between first and second catalyst layers 22, 24, respectively, and further comprises a seal 50 configured to seal MEA 100.

First and/or second GDLs 12, 14 may comprise microporous layer(s). In certain embodiments, first catalyst layer 22 may be a hydrogen-side catalyst layer configured to catalyze hydrogen oxidation and/or hydrogen formation, and second catalyst layer 24 may comprise an oxidant-side catalyst layer configured to catalyze oxygen reduction and/or oxygen formation.

In certain embodiments, the jointing together may be carried out over a joined area which is pressed mechanically and/or crosslinked chemically (indicated schematically as step 440). In certain embodiments, a first portion 30A of thin membrane 30 may be coated on first catalyst layer 22 and a second portion 30B of thin membrane 30 may be coated on second catalyst layer 14, with the joined area joining first and second portions 30A, 30B of thin membrane 30, as illustrated schematically.

In certain embodiments, a free-standing membrane 35 may be set between first and second GDEs 110, 120 (either or both of which may also include coated membrane 30, 30A, 30B as disclosed herein). In certain embodiments, only one, or both, of first and second GDEs 110, 120 may include coated membrane(s) 30A and/or 30B on their respective catalyst layers and free-standing membrane 35 (which may be 30 microns thick or less) may be placed between first and second GDEs 110, 120 facing the coated thin membrane(s) 30A and/or 30B. Any of disclosed MEA embodiments and/or electrochemical device embodiments may include free-standing membrane 35 as disclosed herein in the respective MEAs.

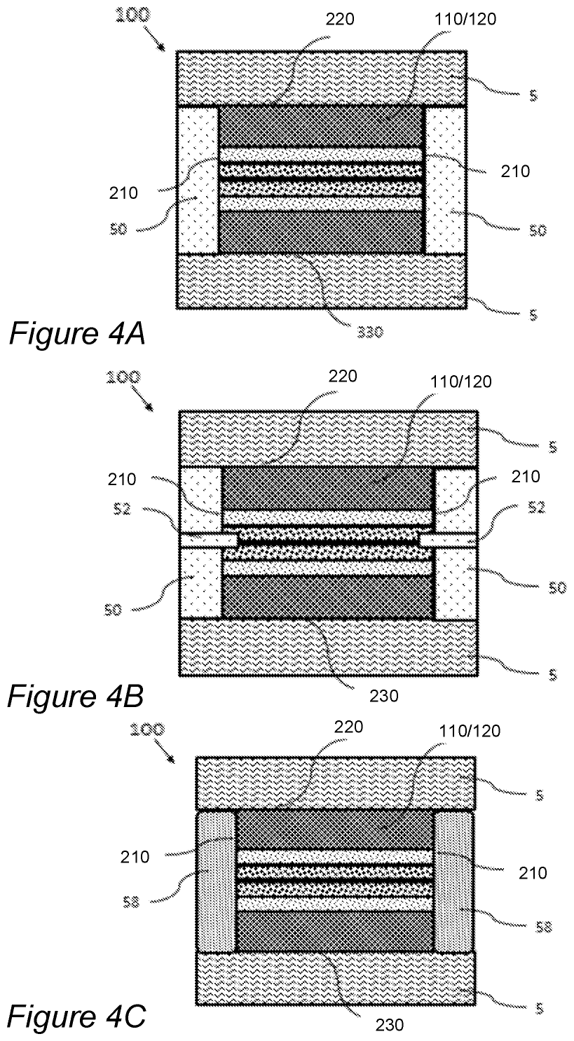

In certain embodiments, the sealing (indicated schematically as step 450) may be applied to all free sides of the MEA, e.g., perpendicularly to the GDEs 110, 120 and their coated layers 22, 24, 30. Seal 30 may comprise an infused sealing material and/or gaskets, and seals all sides of joined first and second GDEs 110, 120, as described, e.g., in FIGS. 4A-4C.

In certain embodiments, multiple MEAs 100 may be joined into a stack 101 (indicated schematically as step 460), with each of MEAs 100 sealed independently of other MEAs 100 in stack 101. Stack 101 may be configured to enable introduction and removal of liquids and/or gases, such as water, air, electrolyte, hydrogen, oxygen, etc. to and from GDEs 110, 120, with respect to the configuration of the electrochemical device in which stack 101 is used, as described herein.

For example, the electrochemical device with stack 101 may comprise a fuel cell 311, with the hydrogen-side catalyst layer being configured to catalyze hydrogen oxidation, and the oxidant-side catalyst layer being configured to catalyze oxygen reduction, with corresponding introduction and removal of liquids and/or gases to and from stack 101.

In another example, the electrochemical device with stack 101 may comprise an electrolyzer 312, with the hydrogen-side catalyst layer being configured to catalyze hydrogen formation, and the oxidant-side catalyst layer being configured to catalyze oxygen formation, with corresponding introduction and removal of liquids and/or gases to and from stack 101.

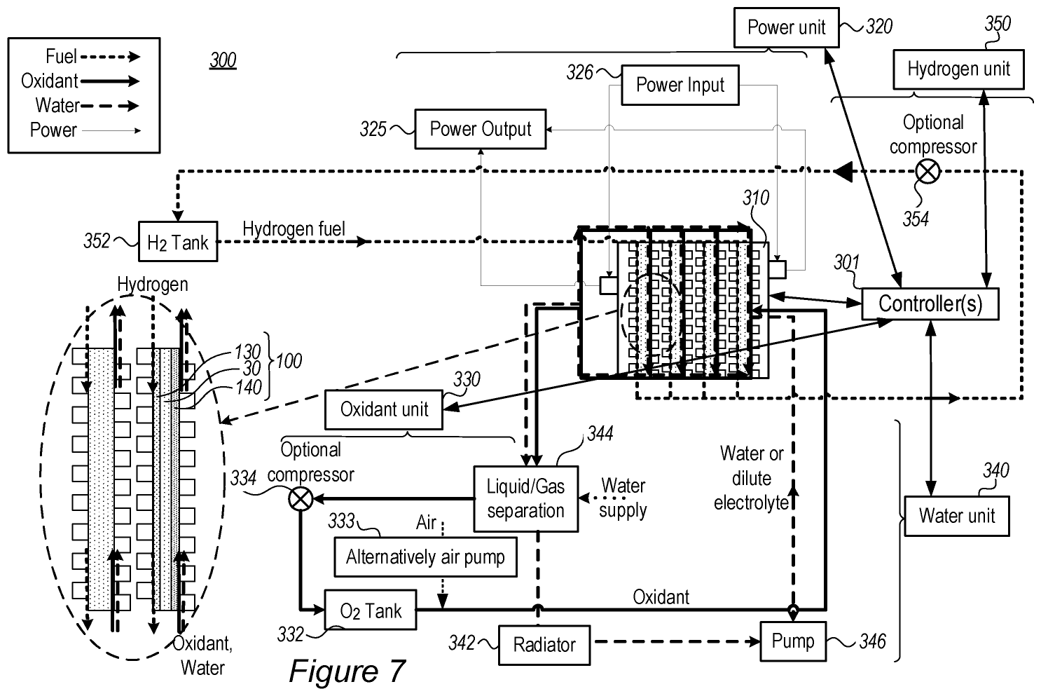

In certain embodiments, the electrochemical device with stack 101 may comprise a reversible device 310 configured to operate alternately as a fuel cell in a fuel cell mode and as an electrolyzer in an electrolyzer mode (see, e.g., FIGS. 7-9), with the hydrogen-side catalyst layer of MEAs 100 being configured to catalyze hydrogen oxidation in the fuel cell mode and to catalyze hydrogen formation in the electrolyzer mode, and the oxidant-side catalyst layer of MEAs 100 being configured to catalyze oxygen reduction in the fuel cell mode and to catalyze oxygen formation in the electrolyzer mode.

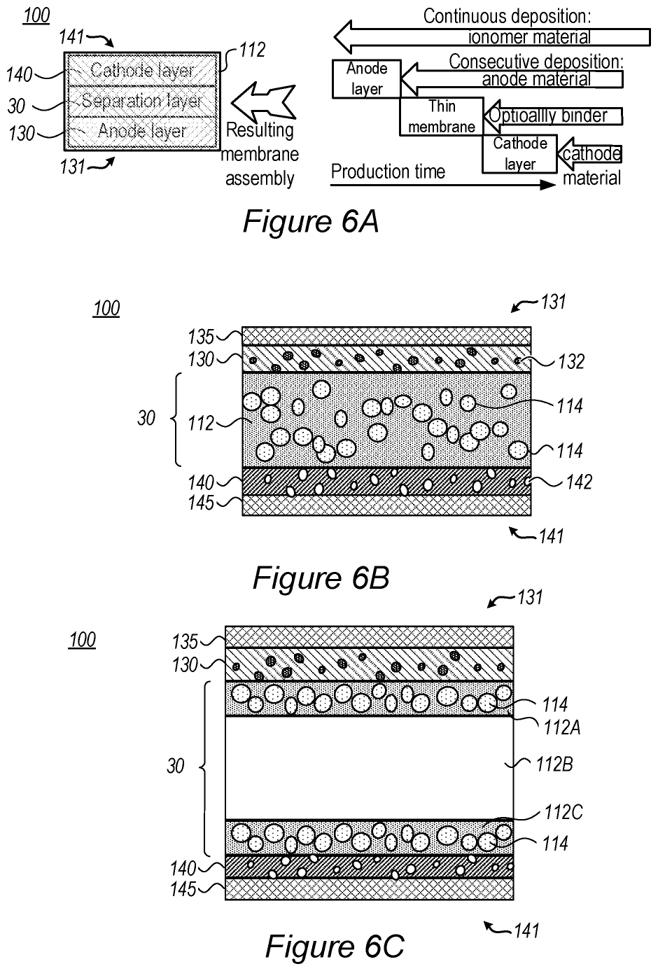

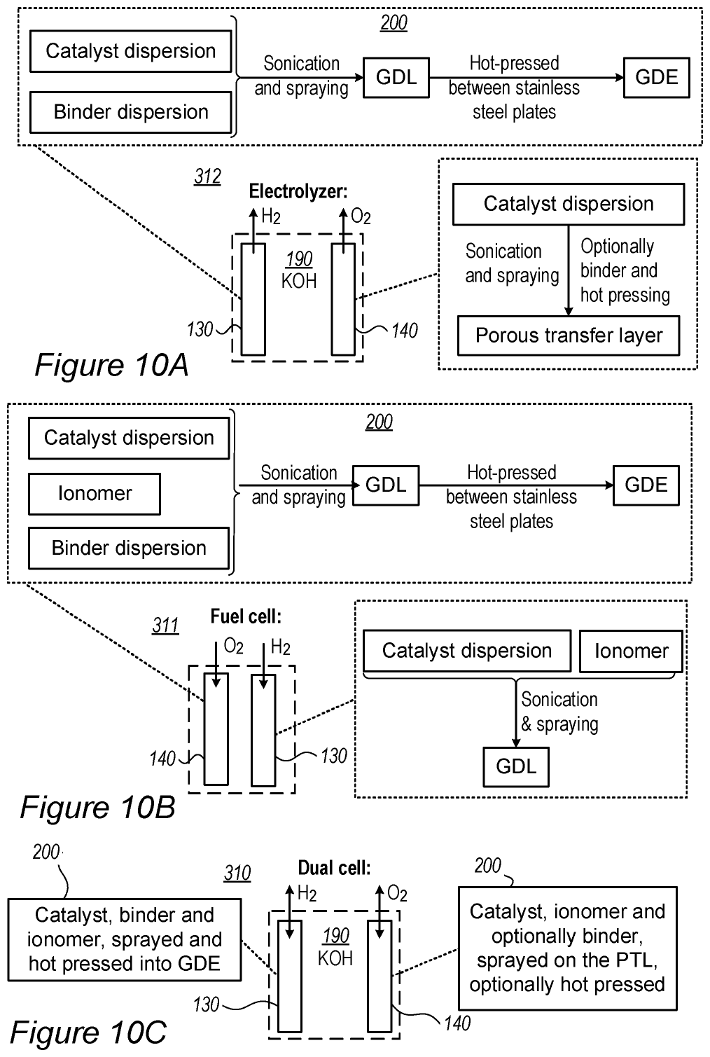

In various embodiments, thin membrane 30 of MEA 100 may comprise ionomer and/or reinforcing nanoparticles as disclosed herein, and may be produced by deposition, coating, spraying, pressing, etc. (see, e.g., FIGS. 6A-6C and 10A-10C).

Some aspects of the present invention may be related to methods of making membrane assemblies that include a thin membrane (e.g., having a thickness of less than 30 microns). In disclosed membrane assemblies, the thin membrane may be deposited directly on at least one catalyst layer as opposed to the standard methods wherein the catalyst layers are deposited on both sides of the membrane to form a CCM. Disclosed methods may allow to reduce the thickness of the membrane to well below 30 microns, for example, below 20 micron, 10 microns and 5 microns. Disclosed thin membranes may have several advantages, for example, dramatic reduction of the swelling phenomenon and the redundancy of the use of mesh as a support, as well as high conductance of the membrane (conductance is conductivity divided by thickness) and higher water permeation.

Furthermore, methods of making disclosed membrane assemblies according to some embodiments of the invention may allow better, simpler and cheaper production of membrane assemblies for fuel cells (e.g., alkaline fuel cells), electrolyzers and/or reversible devices. The method may include preparing or providing an anode gas diffusion electrode (GDE which is an anode catalyst layer deposited on a GDL) and a cathode GDE (cathode catalyst layer deposited on a GDL) following by depositing the thin membrane on one or both catalyst layers of the GDEs and then joining the two GDEs together. GDEs are cheaper than the more expensive CCM. Embodiments of disclosed methods may allow wetting the thin membrane by a base followed by deionized water, to cause ion-exchanging of anions in the membrane, before the joining. This may allow simpler, quicker and more uniform ion-exchanging process in the membrane. In some embodiments, the two GDEs in which at least one is deposited with the thin membrane may be stored as a kit to be joined and optionally ion-exchanged when needed.

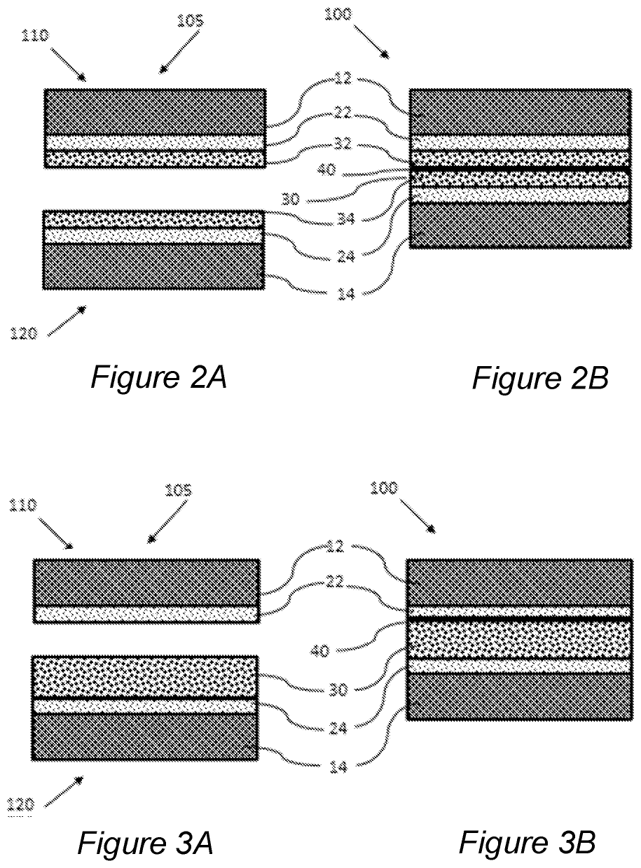

FIGS. 2A and 2B are high-level schematic illustrations of a kit 105 for forming membrane assemblies 100, according to some embodiments of the invention. For example, membrane assemblies 100 may be used in fuel cells (e.g., alkaline fuel cells), electrolyzers and/or reversible devices. In some embodiments, kit 105 for membrane assembly 100 and membrane assembly 100 may include a first gas diffusion electrode 110 and a second gas diffusion electrode 120. First gas diffusion electrode 110 may include a first gas diffusion layer 12 coated with a first catalyst layer 22 and second gas diffusion electrode 120 may include a second gas diffusion layer 14 coated with a second catalyst layer 24. In some embodiments, membrane assembly 100 and/or kit 105 may further include a thin membrane 30 coated on at least one of: a first catalyst layer 22 and a second catalyst layer 24. For example, a first portion 32 of thin membrane 30 may be coated on first catalyst layer 22 and a second portion 34 of thin membrane 30 may be coated on second catalyst layer 24.

Gas diffusion layers (GDLs) 12 and 14 may include any gas diffusion layers known in the art, for example, carbon paper, non-woven carbon felt, woven carbon cloth and the like. In some embodiments, GDLs 12 or 14 may include a microporous layer (MPL), that is made, for example, from sintered carbon/PTFE particles. In some embodiments, GDLs 12 and/or 14 may include the MPL is in order to provide a flat substrate to form a uniform deposition of the catalyst layer,

First catalyst layer 22 may be, for example, an anode catalyst layer that includes ionomer and anode catalyst particles, such as, nanoparticles of: Pt, Ir, Pd, Ru, Ni and the like and alloys of the like. Second catalyst layer 24 may be, for example, a cathode catalyst layers, that includes ionomer and cathode catalyst particles, for example, nanoparticles of: Ag, Ag alloyed with Pd, Cu, Zr and the like. The ionomer included in first catalyst layer 22 and second catalyst layer 24 may be ionomer configured to conduct anions. The ionomers of first catalyst layer 22 and second catalyst layer 24 may be different or may be the same. In some embodiments, ionomers of first catalyst layer 22 and second catalyst layer 24 may be the same as the ionomer of first portion 32 and second portion 34 of thin membrane 30.

In some embodiments, first portion 32 and second portion 34 of thin membrane 30 may include any anion conducting ionomer known in the art, for example, copolymers of (Vinylbenzyl)trimethylammonium chloride, copolymers of diallyldimethylammonium chloride (DADMAC), styrene-based polymer having quaternary ammonium anion conducting group, Bi-Phenyl backboned with two functional groups: an alkene tether group and alkyl halide group, and the like. In some embodiments, the total thickness of thin membrane 30 may be at most 30 microns, for example, at most 20 microns, at most 10 microns and at most 5 microns. In some embodiments, first portion 32 and second portion 34 may further include reinforcing nanoparticles, for increasing the strength of thin membrane 30. For example, the ionomer of thin membrane 30 may be reinforced with, for example, anionic clays, cationic clays, graphene oxide, reduced graphene oxide, zirconium oxide, titanium oxide, polytetrafluoroethylene nanoparticles, boron nitride and the like.

In some embodiments, first gas diffusion electrode 110 and second gas diffusion electrode 120 may be joined together to form membrane assembly 100 such that thin membrane 30 may be located between the first and second catalyst layers 22 and 24. In some embodiments, membrane assembly 100 may include a joined area 40, joining together first gas diffusion electrode 110 and second gas diffusion electrode 120. In some embodiments, joined area 40 may include at least one of: mechanically pressed area and crosslinking chemical bonds.

FIGS. 3A and 3B are high-level schematic illustrations of kit 105 for forming membrane assemblies, according to some embodiments of the invention. In some embodiments, kit 105 for assembling membrane assembly and membrane assembly 100 may include first gas diffusion electrode 110 and second gas diffusion electrode 120. First gas diffusion electrode 110 may include first gas diffusion layer 12 coated with first catalyst layer 22 and second gas diffusion electrode 120 may include a second gas diffusion layer 14 coated with a second catalyst layer 24. In some embodiments, membrane assembly 100 may further include thin membrane 30 coated on second catalyst layer 24.

In some embodiments, thin membrane 30 may include any anion conducting ionomer known in the art, for example, copolymers of (Vinylbenzyl)trimethylammonium chloride, copolymers of diallyldimethylammonium chloride (DADMAC), styrene based polymer having quaternary ammonium anion conducting group, Bi-Phenyl backboned with two functional groups: an alkene tether group and alkyl halide group, and the like. In some embodiments, the total thickness of thin membrane 30 may be at most 30 microns, for example, at most 20 microns, at most 10 microns and at most 5 microns. In some embodiments, thin membrane 30 may further include reinforcing nanoparticles, for increasing the strength of thin membrane 30. For example, the ionomer of thin membrane 30 may be reinforced with, for example, anionic clays, cationic clays, graphene oxide, reduced graphene oxide, zirconium oxide, titanium oxide, polytetrafluoroethylene nanoparticles, boron nitride and the like.

In some embodiments, first gas diffusion electrode 110 and second gas diffusion electrode 120 may be joined together to form membrane assembly 100 such that thin membrane 30 may be located between the first and second catalyst layers 22 and 24. In some embodiments, membrane assembly 100 may include a joined area 40, joining together first gas diffusion electrode 110 and second gas diffusion electrode 120. In some embodiments, joined area 40 may include at least one of: mechanically pressed area and crosslinking chemical bonds.

FIGS. 4A-4C are high-level schematic illustrations of sealed assemblies, according to some embodiments of the invention. In some embodiments, membrane assemblies 100 may further include a seal 50, 52, 58 for sealing the electro-chemically active areas of the membrane assembly. As used herein the electro-chemically active areas are areas at which electro-chemical reactions and ion conduction is taking place. In some embodiments, the electro-chemically active areas may include the GDLs, the catalyst layers and the membrane. In some embodiments, the seal may be configured to seal membrane assemblies 100 from all sides (indicated schematically by numeral 210) substantially perpendicular to surfaces 220 and 230 of first and second gas diffusion electrodes 110 and 120. In some embodiments, the seal may also be held between two flow fields 5.

In some embodiments, the seal may include two or more gaskets 50, as illustrated in FIG. 4A. Gaskets 50 may include any flexible sealing material that may be configured to fit (optionally under pressure) and fill the entire space from all sides (indicated schematically by numeral 210) substantially perpendicular to surfaces 220 and 230 of first and second gas diffusion electrodes 110 and 120. For example, gaskets 50 may include any type of elastomers either thermoset or thermoplastic, for example, SBS, SEBS, thermoplastic polyurethanes, fluoro-elastomers, SBR, NBR, EDPM, BR, epichlorohydrin, silicone rubbers, fluorinated thermoset rubbers, thermoset polyurethanes and the like. In some embodiments, at least one of the two or more gaskets 50 may include a ridged material, for example, Kapton (polyimide), PTFE and the like.

In some embodiments, additional sub gaskets 52 may be added to further seal the chemically active areas, as illustrated in FIG. 4B. Sub-gaskets may further seal the active area. For example, sub-gaskets 52 may include any type of sealing material either elastic or rigid. In some embodiments, the sub-gaskets may be made from the same material as gaskets 50. In some sub-gaskets 52 may be made from a rigid material, for example, Kapton (polyimide), PTFE and the like.

In some embodiments, a sealing material 58 may be infused to seal membrane assemblies 100 from all sides (indicated schematically by numeral 210) substantially perpendicular to surfaces 220 and 230 of first and second gas diffusion electrodes 110 and 120. Sealing material 58, may be any flowable material that can be infused to completely fill the entire space from all sides (indicated schematically by numeral 210). Sealing material 58 may include a silicone-based polymer, for example, a thermoset silicone rubber, a thermoplastic such as polyurethane and the like.

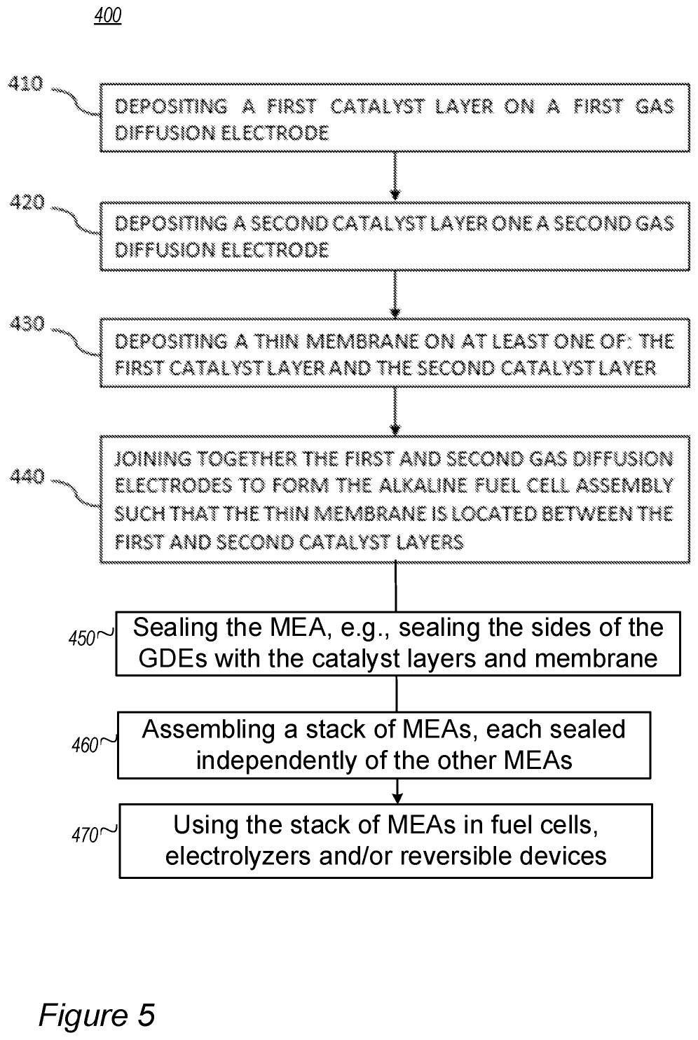

FIG. 5 is a high-level schematic flowchart of a method 400 of making membrane assemblies, according to some embodiments of the invention. In some embodiments, in step 410, a first catalyst layer (e.g., an anode catalyst layer) may be deposited on a first gas diffusion layer to form a first gas diffusion electrode (GDE). In some embodiments, a first GDE may already be provided with a first catalyst layer deposited on a GDL. In some embodiments, the GDL may be provided, and the catalyst layer may be deposited on one surface of the GDL, using any known method, for example, spraying, electrospray coating, slot die casting, printing and the like.

In some embodiments, in step 420, a second catalyst layer (e.g., a cathode catalyst layer) may be deposited on a second gas diffusion layer to form a second gas diffusion electrode (GDE). In some embodiments, a second GDE may already be provided with the second catalyst layer deposited on the second GDL. In some embodiments, the GDL may be provided and the catalyst layer may be deposited on one surface of the GDL, using any known method, for example, spraying, electrospray coating, slot die casting, printing and the like.

In some embodiments, in step 430, a thin membrane may be deposited on at least one of: the first catalyst layer and the second catalyst layer. For example, the thin membrane may be deposited on at least one of the first catalyst layer of the first GDE or the second catalyst layer of the second GDE (as illustrated, e.g., in FIG. 3A). Alternatively, a first portion of the thin membrane may be deposited on the first catalyst layer and a second portion of the thin membrane may be deposited on the second catalyst layer (as illustrated, e.g., in FIG. 2A). In some embodiments, a dispersion for forming the thin membrane may be deposited using any known method, for example, spraying, electrospray coating, slot die casting, printing and the like. The dispersion may include monomers that may or may not include functional groups for forming the ionomer (functionalized monomers). Some examples of functional monomers may include, Vinylbenzyl)trimethylammonium chloride, dimethylammonium chloride (DADMAC) and the like. Some examples of functional or non-functional co-monomers may include, styrene, divinyl benzene, isoprene, butadiene, acrylamide and the like. The monomers may then be polymerized following the deposition. Alternatively, the dispersion may include already polymerized polymer chains either with or without functional groups, for example, poly(vinyl benzene chloride) and its copolymers, poly(vinylbenzyl)trimethylammonium chloride) and its copolymers, poly(diallyldimethyl ammonium chloride) and the like. In some embodiments, if the monomers or polymers in the dispersion are not functionalized, embodiments may include functionalizing the deposited membrane. For example, transforming a chloromethylated group (non-functional) to a trimethylammonium group (functional), following by adding trimethylamine (TMA) to cause a chemical reaction is known in the art as “quaternization”.

In some embodiments, depositing the thin membrane may include depositing two or more layers each comprising a different ionomer. In some embodiments, the ionomers may be different by at least one of: the chemical composition and/or the ion-exchange capacity (IEC). For example, two different types of ionomers may be deposited to form a thin membrane, for example, using any two of the materials disclosed with respect to step 430. Additionally or alternatively, the same ionomer may be deposited having different IEC (the concentration of functional groups in the polymer). For example, an ionomer having a lower IEC (e.g., 0.2-6 mmol/gr) may be deposited at the anode side, for example, at the first portion of the thin membrane and an ionomer having a higher IEC (e.g., 0.2-6 mmol/gr) may be deposited at the cathode side, for example, at the second portion of the thin membrane.

In some embodiments, the polymers in the thin membrane may further be crosslinked using any suitable crosslinking agent, for example, Divinylbenzne, N,N,N′,N′-Tetramethyl-1,6-hexanediamine (TMHDA), 1,4-diazabicyclo[2.2.2]octane (DABCO), glyoxal, glutaraldehyde, hydrocarbon chains, sulfur groups, siloxy groups, N-hydroxybenzotriazole groups, azide groups and the like. As should be understood by one skilled in the art the crosslinking agent may be selected according to the type of the ionomer to be crosslinked. Additionally or alternatively, the thin membrane may be crosslinked to at least one of the first catalyst layer and the second catalyst layer.

In some embodiments, in step 440, the first and second gas diffusion electrodes may be joined together to form the membrane assembly such that the thin membrane is located between the first and second catalyst layers. For example, the first GDE may be joined to the second GDE having the thin membrane deposited thereon (as illustrated, e.g., in FIGS. 3A and 3B). Alternatively, the first portion of the thin membrane and the second portion of the thin membrane may be joined together (e.g., as illustrated, e.g., in FIGS. 2A and 2B). The two GDEs may be joined by at least one of: mechanically pressing together the first and second gas diffusion electrodes and physico-chemical bonding that includes crosslinking the joined area. The two GDEs may be pressed together either with or without an additional heat. Alternatively, the two GDEs may be attached to each other and then crosslinked by adding a crosslinking agent to the thin membrane dispersion. As should be understood by one skilled in the art, the two disclosed joining methods are given as non-limiting examples only and the invention as a whole is not limited to a specific from of joining.

In some embodiments, method 400 may further include wetting the thin membrane by a base followed by de-ionized water, to cause ion-exchanging of anions in the membrane into anions, prior to the joining. In some embodiments, the anions to be exchanged may include OH⁻, HCO₃⁻, CO₃²⁻, and the like. Some examples for such bases may include sodium hydroxide (NaOH), potassium hydroxide (KOH), sodium carbonate (Na₂CO₃), potassium carbonate (K₂CO₃), sodium bicarbonate (NaHCO₃), potassium bicarbonate (KHCO₃) and the like.

In some embodiments, method 400 may further include sealing the alkaline membrane assembly (step 450), e.g., from all sides substantially perpendicular to surfaces of the first and the second gas diffusion electrodes. In some embodiments, sealing 450 may include adding gaskets to the sides perpendicular to the surfaces of the GDEs. In some embodiments, sealing may include infusing a sealing material from all the sides substantially perpendicular to of the first and the second gas diffusion electrodes.

Method 400 may further comprise assembling a stack of the MEAs, each sealed independently of the other MEAs (stage 460) and enabling introduction and removal of liquids and/or gases, such as water, air, electrolyte, hydrogen, oxygen, etc. to and from the GDEs 110, 120. Method 400 may further comprise using the stack of MEAs in fuel cells, electrolyzers and/or reversible devices (stage 470), with the corresponding configurations of GDEs and fluid introduction and removal.

FIGS. 6A-6C provide non-limiting examples for membrane assemblies 100, according to some embodiments of the invention. In various embodiments, membrane assemblies 100 may be designed to be part of reversible device 310 which comprises one or more electrochemical cells that can function both in fuel cell mode 90A and in electrolyzer mode 90B, depending on inputs and control of reversible device 310 and system 300. Separation layer(s) 30 and/or membrane assemblies 100 may be optimized to enable efficient operation of reversible devices 310 in both fuel cell and electrolyzer modes.

It is noted that each of catalyst layers 130, 140 may comprise either of catalyst layers 22, 24, and may be understood in a general sense to include supporting GDLs 12, 14 so that catalyst layers 130, 140 represent in FIGS. 7-9 whole GDEs 110, 120. Clearly, either of catalyst layers 130, 140 may refer to one or the other of GDEs 110, 120 or their corresponding catalyst layers 22, 24, with the other one of catalyst layers 130, 140 referring to other one of GDEs 110, 120 or their corresponding other catalyst layers 22, 24. Similarly, GDLs 135, 145 may correspond to GDLs 12, 14, in any order (GDLs 135 corresponding to GDL 12 or 14, and GDL 145 corresponding to the other GDL 14 or 12).

In non-limiting examples, as illustrated e.g., in FIG. 6A, disclosed membrane assemblies 100 may comprise at least one pair of catalyst layers (electrodes) 130, 140 separated by separation layer 30 which may comprise thin membrane 30, and all embedded in continuous polymerized ionomer material 112 (illustrated schematically overlapping and throughout layers 130, 30, 140, with narrow margins that are optional and illustrated mainly for clarity of the explanation). Membrane assemblies 100 may be produced by continuous deposition of ionomer material on a substrate and, during the continuous depositing of the ionomer material—depositing in consecutive steps anode material, optionally separator material and cathode material—to embed in continuous polymerized ionomer material the anode material and the cathode material, separated by separation layer 30 (that may comprise only the ionomer material and/or optionally additional binder material). It is noted that the order of the layers may be reversed, e.g., first depositing one catalyst layer 140, then separation layer 30 and then another layer 130, and/or multiple sets of layers may be deposited in a single process. Membrane assemblies 100 may be attached to corresponding substrate (e.g., GDL) on either or both sides, contacting either or both catalyst layers 130, 140. Various embodiments of membrane assemblies 100 are disclosed in WIPO Patent Application No. PCT/IL2022/050091 and are incorporated herein by reference in their entirety. For example, ionomer material 112 may comprise electrospun nanofibers and electrodes 130, 140 may comprise corresponding catalyst particles that may be electrosprayed in association with the electrospun ionomer material 112. Alternatively or complementarily, ionomer material 112 may comprise electrosprayed material and electrodes 130, 140 may comprise corresponding electrospun catalyst fibers in association with the electrosprayed ionomer material 112. In certain embodiments, catalyst material of either or both electrodes 130, 140 may be electrospun together with ionomer material 112.

In non-limiting examples, as illustrated e.g., in FIGS. 6B and 6C, disclosed membrane assemblies 100 may comprise, between electrodes 130, 140, separation layer 30 that is made of one or more layers of polymer matrix 112 and ion-conductive particles 114, and may be relatively thick (e.g., tens of μm, and up to 100-200 μm). Polymer matrix 112 may comprise ionomer material(s) 112 and have high ion conductivity (e.g., between 10 mS/cm and more than 180 mS/cm, or any intermediate values), while particles 114 may be used to improve mechanical properties, (for example, yield stress, strain at break, resistance to creep, or other desirable properties, as can be measured comparatively with equivalent polymer without ceramic additives) and possibly also improve the ion conductivity of separation layer 30. Alternatively or complementarily, polymer matrix 112 may have low ionic conductivity and include a high solid content (e.g., over 60%, 70%, 80%, 85%, 90% or more by weight) of ion-conductive particles 114. Various embodiments of membrane assemblies 100 are disclosed in WIPO Patent Application No. PCT/IL2021/051524 and are incorporated herein by reference in their entirety. For example, separation layer 30 may comprise multiple layers made of different materials and/or comprising different amounts or types of ion-conductive particles 114. For example, separation layer 30 may comprise a middle polymeric layer that is ion conductive (e.g., have an ion conductance that is larger of any of 5 S/cm², 10 S/cm², 20 S/cm², 20 S·cm⁻², 50 S·cm⁻², 100 S·cm⁻², or any intermediate values. In various embodiments separation layer 30 may be made of ionomer material and may be from about 5 μm thick, and up to 100-200 μm thick (or have intermediate values, e.g., between any of 5 μm to 30 μm, 10 μm to 50 μm, 30 μm to 100 μm, 10 μm to 200 μm or within other subranges, e.g., within 50-80 μm), and flanking thin layers of polymer matrix with ion-conductive particles 114 embedded therein, e.g., few to tens of μm thick, which interface electrodes 130, 140. In certain embodiments, separation layer 30 may comprise two or more polymer layers which may be ionomeric and have high ion conductivity, interspaced by three or more thinner composite layers configured to strengthen separation layer 30 mechanically and protect the edges of polymer layers that interface electrodes 130, 140 from dehydration (during device operation) and/or chemical degradation by exposure to dry gases and/or catalytically active materials. For example, FIG. 6C illustrates schematically protective layers 112A, 112C flanking central polymeric layer 112B (in some embodiments an additional composite layer may be set to split polymer layer 112B in two). Composite layers 112A, 112C, when thin, may even be porous, as the main gas barriers are the thicker polymer layers that may be selected to provide overall sufficient ion conductance over the full stack, which is sufficiently blocking gas and liquid crossover. For example, separation layer(s) 30 may be configured to have a total ASR that is smaller than 200 Ω·cm², smaller than 100 Ω·cm², smaller than 50 Ω·cm², smaller than 15 Ω·cm², or having intermediate ASR values. Separation layer(s) 30 may be configured to have these ASR values while keeping their area-specific hydrogen permeation values smaller than about 10⁻⁷ mol/s/m²/Pa in fuel cell mode, and smaller than about 10⁻⁸ mol/s/m²/Pa or even lower in electrolyzer mode, depending on the desired degree of hydrogen pressurization. In certain embodiments, separation layer 30 may comprise one-sided protection of a thicker polymer layer by a thinner composite layer (e.g., only one of layers 112A, 112C on one side of polymer layer 112B) that interfaces only one of electrodes 130, 140. Component layers of separation layer(s) 30 may be selected to have specific characteristics relating to their order in the stack and the functioning of device 310. For example, the layers may be selected from: (i) ionomeric layer, (ii) ionomeric layer with particles for added strength, (iii) ionomeric layer with ion-conductive particles for added strength and enhanced ion conductivity, (iv) passive or even porous polymer layer with high concentration of ion-conductive particles for added strength and ion conductivity, as well as protection against dehydration of ionomeric layers, (v) thin passive polymer layer with low concentration of ion-conductive particles for added ion conductivity, and so forth, for any required combination of features. Separation layer(s) 30 may be produced in a range of ways, including attachment of free membrane layers, deposition of consecutive layers on a substrate (e.g., on electrodes 130, 140 and/or GDLs 135, 145) and/or combinations thereof. Formation of individual layers may be carried out by polymerization of respective monomers (and/or oligomers), including or followed by any of cross-linking polymer chains, functionalization into ionomers if needed and/or mixture of particles that are ion-conductive or not, into any of the fluid precursor(s) prior to polymerization. Individual layers may then be attached to form separation layer 30 and/or consecutive layers 30 may deposited onto respective substrates, followed by drying (or optionally peeling in case of using a sacrificial substrate).

In some embodiments, particles 114 may be surface-charged and ion-conducting in hydrated media by means of excess surface charge. For example, nanoparticles 114 may comprise nanoparticles of any of LDH (as ion-conductive particles 114), bentonite, montmorillonite, laponite, smectite, halloysite, cloisite, hydrotalcite (as non-limiting examples for charged clay particles 114), zirconium oxide, titanium oxide (as non-limiting examples for surface charged non-clay ceramic particles 114), graphene oxide, reduced or partially reduced graphene oxide, boron nitride, functionalized polyethylene, polytetrafluoroethylene, poly(ethylene tetrafluoroethylene) or other polymer nanoparticles, or their combinations, configured as surface charged particles 114. In non-limiting examples, nanoparticles 114 may include any type of chemically inactive nanoparticles that do not react chemically or electrochemically with the anions or cations conducted through separation layer(s) 30 and with chemical reactions taking place in the respective membrane assembly 100. It is noted that particles 114 may only be ion conducting to some extent, and not interact chemically in any other way. In some embodiments, chemically inactive nanoparticles 114 may be configured to reinforce ionomer matrix 112 and increase its mechanical strength. In some embodiments, the amount of chemically inactive nanoparticles maybe at least any of 1, 2, 5 or 10 weight %, or intermediate values for layers with low solid content, 20-50 weight % or intermediate values for layers with medium solid content, or 50-90 weight % or even up to 100 weight %, or intermediate values, for layers with high solid content—used in dependence of the layer thickness and function with the stack, as explained herein.

In various embodiments, at least some of separation layer(s) 30 may comprise both chemically inactive nanoparticles and chemically active particles as particles 114. In various embodiments, at least some of separation layer(s) 30 may comprise both surface-charged particles and uncharged particles as particles 114. In various embodiments, separation layer 30 may be configured to comprise a combination of (i) ion-conductive clay nanoparticles 114 (e.g., charged ceramic particles or other surface-charged particles) comprising a high solid component (e.g., 70-100% weight % of particles) combined with (ii) neutral, stable polymer (e.g., as matrix 112) to form one or more high-temperature stable composite separation layer(s) 30. In various embodiments, protective layer(s) 112A, 112C may be formed on the surface of separation layer 30 (e.g., on polymer layer 112B) and/or on layers thereof to enhance stability, durability, strength or reduce gas crossover, with any combination of low, medium or high solids content, being a porous or non-porous layer, and using ion-conducting or non-conducting solid particles and polymer binder. Protective layer(s) 112A, 112C may be configured to allow sufficient ion conductance and water permeation, by adjusting the thickness of protective layer(s) 112A, 112C within a range between a few nanometers to a few microns, or up to about ten microns, or according to the requirements of the specific application.

In non-limiting examples, hydrogen-side catalyst layer 130 may include ionomer(s) with embedded hydrogen oxidizing and/or hydrogen evolving (generating) catalyst particles 132 such as nanoparticles made of any of Pt, Ir, Pd, Ru, Ni, Co, Fe and their alloys, blends and/or combinations, optionally supported on carbon or other conducting substrates. Alternatively or complementarily, hydrogen-side catalyst layer 130 may comprise modified carbons with embedded catalytic groups such as nitrides or various transition metals. Alternatively or complementarily, hydrogen-side catalyst layer 130 may comprise transition metal oxides or hydroxides based on Ni, Co, Mn, Mo, Fe, etc., nitrogen-doped and/or metal-doped carbon materials. Hydrogen-side catalyst layer 130 may be between 2 μm to 20 μm thick (or within subranges such as 2 μm to 5 μm, 5 μm to 10 μm, 10 μm to 15 μm, 15 μm to 20 μm, or other intermediate ranges) and may have an ionomer content of between 0% to 40% w/w (or within subranges such as 0% to 10% w/w, 5% to 20% w/w, 10% to 30% w/w, 20% to 40% w/w, or other intermediate ranges). Hydrogen-side catalyst layer 130 may be configured to be stable over the full voltage range of electrode operation, e.g., from under about −0.2 V in electrolyzer mode to over about +0.4V in fuel cell mode, versus a reversing hydrogen electrode.

Typical oxygen-side catalysts comprise metal oxide(s) and/or or metal hydroxide(s) that are stable over the full voltage range of electrode operation, e.g., from under about 0.6V in fuel cell mode to about 2.0V in electrolyzer mode versus a reversing hydrogen electrode. In non-limiting examples, oxygen-side catalyst layer 140 may include ionomer(s) with embedded cathode catalyst particles 142 such as nanoparticles made of oxygen reducing and/or oxygen evolving (generating) catalysts made of any of Ag, Ag alloyed with Pt, Pd, Cu, Zr, Ag, Ni, Fe, Mn, Co, Pt, Ir, Ru their alloys, blends and/or combinations, possibly combined with metal oxides such as, e.g., cerium oxide, zirconium oxide, their alloys, blends and/or combinations. Alternatively or complementarily, oxygen-side catalyst layer 140 may comprise the metal particles in oxide or hydroxide form and/or include surface oxide or hydroxide layers. Alternatively or complementarily, oxygen-side catalyst layer 140 may comprise transition metal(s), metal oxide(s) and/or metal hydroxide(s) that are based on Ni, Fe, Co, Mn, Mo and their alloys, mixed oxides or mixed hydroxides such as spinel, perovskite or layered double hydroxide (LDH) structures, potentially doped with or loaded with Pt, Ir, Ru, Ag or other elements to enhance oxygen generation and/or reduction performance. Oxygen-side catalyst layer 140 may be 10 μm to 30 μm thick.

Gas diffusion layer(s) (GDLs) 135 and/or 145 may include any type of gas diffusion layers such as carbon paper, non-woven carbon felt, woven carbon cloth and the like, nickel, titanium or stainless steel meshes, felts, foams, sintered microspheres, or other porous and electrically conductive substrates. In some embodiments, GDLs 135 and/or 145 may be attached to a microporous layer (MPL), made, e.g., from sintered carbon and/or optionally polytetrafluoroethylene (PTFE) or other hydrophobic particles, or from various porous metallic or other porous conductive layers.

In non-limiting examples of AEM implementations, ionomeric material matrix 112 may comprise a continuous anion conducting ionomer comprising, e.g., polymers or copolymers of (vinylbenzyl)trimethylammonium chloride, wherein the chloride counterion may be exchanged to any desired anion, copolymers of diallyldimethylammonium chloride (DADMAC), wherein the counterion may be exchanged to any desired anion, styrene-based polymers having quaternary ammonium anion conducting group, quaternized poly(vinylalcohol) (QPVA), bi-phenyl or tri-phenyl backboned polymers with one or more functional groups that could include alkyl tether group(s) and/or alkyl halide group(s) and/or equivalent groups, poly(arylpiperidinium) and other polymers containing cyclic quaternary ammonium in the backbone or on tethered sidechains, poly(bis-arylimidazoliums), cation-functionalized poly(norbornenes), neutral polymers or polymer membranes with grafted anion-conductive sidechains, or any other anion-conducting polymer. In some embodiments, the anion conducting ionomer may be crosslinked, e.g., using crosslinking agent(s) selected according to the type of the ionomer to be crosslinked, such as divinylbenzne, N,N,N′,N′-tetramethyl-1,6-hexanediamine (TMHDA), 1,4-diazabicyclo[2.2.2]octane (DABCO), glyoxal, glutaraldehyde, styrene based polymer(s) having quaternary ammonium anion conducting group(s), bi-phenyl or tri-phenyl backboned with one or more functional groups that could include alkene tether group(s) and/or alkyl halide group(s) and/or equivalent groups, hydrocarbon chains, sulfur groups, siloxy groups, N-hydroxybenzotriazole groups, azide groups and the like. In some embodiments, the anion conducting ionomer may be a blend of several polymers, some of which may not be anion conducting.

In non-limiting examples of PEM implementations, ionomeric material matrix 112 may comprise a continuous cation conducting ionomer comprising, e.g., poly(aryl sulfones), perfluorinated polysulfonic acids such as Nafion®, polymers or copolymers of styrene sulfonic acid with various modifications, sulfonated polyimides, phosphoric acid-doped poly(benzimidazole), sulfonated poly(arylene ethers) such as sulfonated poly (ether ether ketone) (SPEEK) and/or other synthetic or natural cation exchange ionomers.

Specific examples and implementations are described in Israeli Patent Application No. 297987 and in Israeli Patent No. 282438, which are incorporated herein by reference in their entirety.

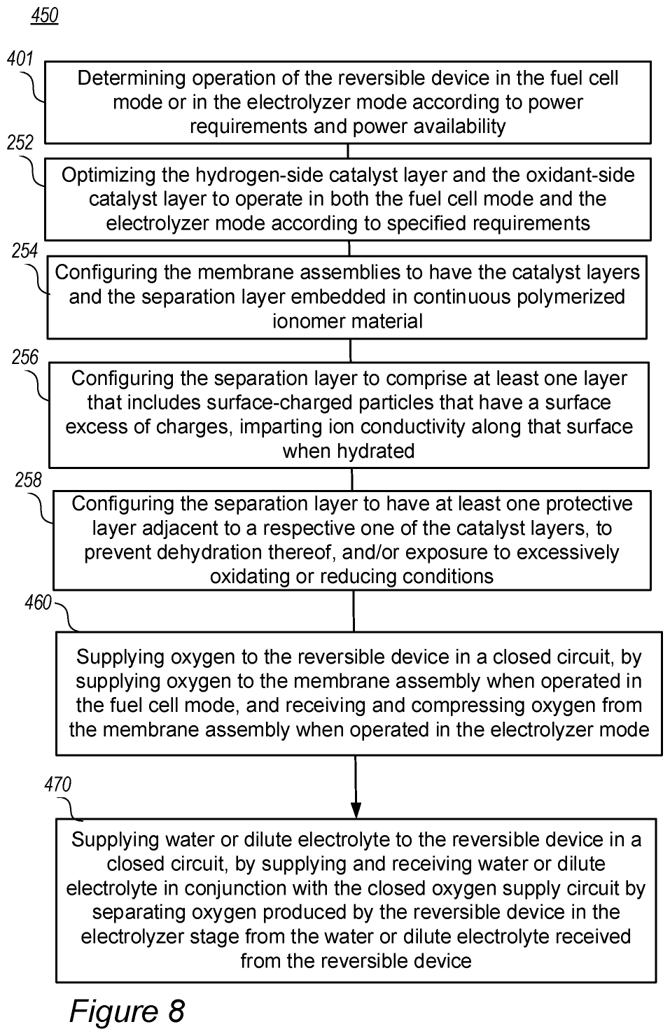

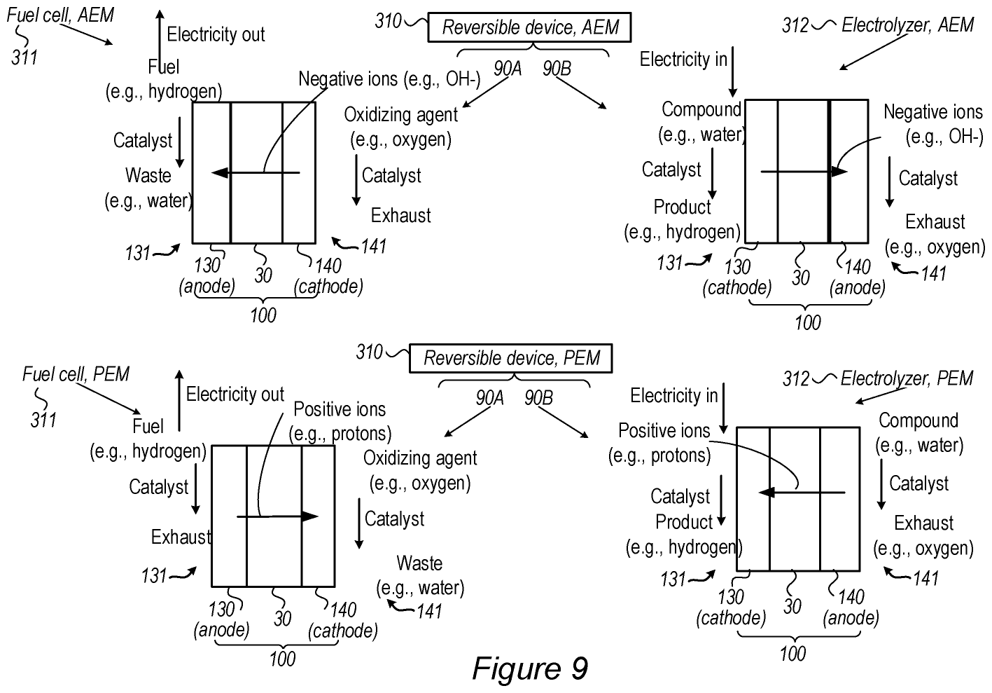

FIG. 7 is a high-level schematic illustration of a self-refueling power-generating system 300 with reversible devices 310, according to some embodiments of the invention. FIG. 8 is a high-level flowchart illustrating a method 450 of configuring a power-generating system to be self-refueling and self-sustaining, according to some embodiments of the invention. FIG. 9 is a high-level schematic illustration of the operation of AEM and PEM reversible devices 310 in fuel cell mode 90A and in electrolyzer mode 90B, according to some embodiments of the invention.

As illustrated schematically in FIG. 7, self-refueling power-generating system 300 comprises one or more reversible device 310 comprising a stack of one or more electrochemical cells with respective membrane assemblies 100. Reversible device 310 is configured to be operated alternately as a fuel cell in a fuel cell mode and as an electrolyzer in an electrolyzer mode (see FIG. 9). Each of membrane assemblies 100 has a hydrogen-side (131) catalyst layer 130 configured to catalyze hydrogen oxidation in the fuel cell mode and to catalyze hydrogen formation (from water electrolysis) in the electrolyzer mode and an oxidant-side (141) catalyst layer 140 configured to catalyze oxygen reduction in the fuel cell mode and to catalyze oxygen formation (from water electrolysis) in the electrolyzer mode. Each of catalyst layers 130, 140 may comprise either of catalyst layers 22, 24, and may be understood in a general sense to include supporting GDLs 12, 14 so that catalyst layers 130, 140 represent in FIGS. 7-9 whole GDEs 110, 120. Clearly, either of catalyst layers 130, 140 may refer to one or the other of GDEs 110, 120 or their corresponding catalyst layers 22, 24, with the other one of catalyst layers 130, 140 referring to other one of GDEs 110, 120 or their corresponding other catalyst layers 22, 24.

Catalyst layers 130, 140 may be arranged in pairs and be separated by a separation layer 30 that comprises thin membrane 30 that allows ion transfer therethrough, anions in AEM configurations and protons in PEM configurations. Separation layer 30 may comprise a single layer, a composite layer, or multiple layers, each of which may be simple or composite, as disclosed below. System 300 further comprises one or more controller 301 configured to determine operation of reversible device 310 in the fuel cell mode or in the electrolyzer mode Schematic illustrations of operation of reversible device 310 in fuel cell mode 90A and in electrolyzer mode 90B are provided in FIG. 9. The stack may comprise a single bifunctional stack with a plurality of electrochemical cells with respective membrane assemblies 100, that functions, as a single stack, in both fuel cell and electrolyzer operation modes. In various embodiments, the stack may comprise two, three, five, ten, twenty, fifty or more cells, or an intermediate number of cells.

Membrane assemblies 100 may comprise single layered or multi-layered solid state polymer membranes. For example, polymer membranes may be based on an ion-conducting polymer, and be able to transport water and anions and/or cations from one electrode to the other during operation. Membrane assemblies 100 may comprise (i) at least one catalyst layer comprising, on an oxygen side 141 of membrane assembly 100: oxygen generating catalyst layer(s), oxygen reducing catalyst layer(s) and/or bifunctional catalyst layer(s) capable of oxygen generation as well as oxygen reduction; and (ii) at least one catalyst layer comprising, on a hydrogen side 131 of membrane assembly 100: hydrogen generating catalyst layer(s), hydrogen oxidizing catalyst layer(s) and/or bifunctional catalyst layer(s) capable of hydrogen generation as well as hydrogen oxidation.

It is noted that either of catalyst layers 131, 141 may comprise one or more materials, and may include different materials to support the opposite catalytic reactions. For example, catalyst layer of oxygen-side electrode 140 on oxygen side 141 may comprise one or more materials to generate oxygen and one or more same or different materials to reduce oxygen, while catalyst layer of hydrogen-side electrode 130 on hydrogen side 131 may comprise one or more materials to generate hydrogen and one or more same or different materials to oxidize hydrogen. It is further noted that catalyst materials for one direction of operation (fuel cell mode 90A or electrolysis mode 90B) may be more efficient than the catalyst materials for the opposite direction of operation, depending, e.g., on the expected operation profile of reversible system 300 (e.g., on the required power supply rate and/or on the hydrogen refilling rate). It is further noted that other than prior art such as U.S. Patent Application Publication No. 20130146471, multiple catalyst materials may be integrated in a single respective catalyst layer that is operative in both reaction directions, in both fuel cell mode 90A and electrolysis mode 90B, and are not separated into two or more distinguishable layers. Examples for catalyst materials are provided below.

Self-refueling power-generating system 300 further comprises an oxidant unit 330 configured to supply oxygen or air to reversible device 310 when operated in fuel cell mode, and optionally receive oxygen from reversible device 310 when operated in electrolyzer mode. Optionally, oxidant unit 330 may comprise an oxygen tank 332 for storing oxygen and may comprise a compressor 334 for compressing oxygen received from AEM device 310 into oxygen tank 332. Alternatively, oxygen compression may be provided by AEM device 310 during its operation as an electrolyzer in the electrolyzer mode. Supplying pure oxygen to oxygen-side electrode 140 during power generation in fuel cell mode may increase the efficiency of system 300 as well as simplify system 300 by making use of the oxygen produced together with hydrogen generation in the electrolyzer mode—possibly yielding a closed oxygen circuit. If needed, any of an additional pump, a CO₂ filter and/or a humidification unit may be included in the closed oxygen circuit.

Self-refueling power-generating system 300 further comprises a hydrogen unit 350 configured to supply hydrogen to reversible device 310 when operated in fuel cell mode, and optionally receive hydrogen from reversible device 310 when operated in electrolyzer mode. Optionally, hydrogen unit 350 may comprise a hydrogen tank 352 for storing hydrogen and may comprise a compressor 354 for compressing hydrogen received from AEM device 310 into hydrogen tank 352. In electrolyzer mode, the generated hydrogen may be passed through a drying unit (not shown) and compressed, optionally electrochemically within AEM device 310, or optionally with the use of a mechanical, electrochemical or other compressor 354.

Self-refueling power-generating system 300 further comprises a water unit 340 configured to supply water (indicated schematically) and/or dilute electrolyte to reversible device 310. Water unit 340 may comprise a radiator 342 for dissipating heat and condensing water from reversible device 310 in the fuel cell mode, a liquid/gas separation module 344 for removing gases such as oxygen from the fluids received from reversible device 310 and a water pump 346 for pumping water to reversible device 310. Dilute alkaline electrolyte (e.g., at concentration lower than 3M) and/or deionized water may be circulated to control the operation temperature. The water circulation may be controlled to maintain the optimal operation temperatures in the fuel cell and electrolyzer modes. The circulated water or alkaline water may be supplied directly to oxygen side 141 (adjacent to oxygen-side catalyst layer 140) via a circulation circuit which also serves as the water supply for hydrogen generation in the electrolyzer mode. Water that is generated by consumption of hydrogen during power generation in the fuel cell mode, may optionally be separated from the reactant gas/gases and returned to the water circulation circuit to replenish any water consumed during the hydrogen generation in the electrolyzer mode. Supply of water or dilute electrolyte to reversible device 310 may be carried out in a closed circuit and in conjunction with the supply of oxygen to reversible device 310.

In certain embodiments, gas/liquid separation module 344 may be configured to deliver separated oxygen from reversible device 310 (produced in electrolyzer mode) to oxidant unit 330, e.g., to compressor 334 and stored in an oxygen tank 332 (or alternatively using an air pump 333 for pumping, e.g., ambient air to supply oxidant). Water circulation may be provided directly to oxygen side 141 of reversible device 310 and the water may optionally be made alkaline by the addition of KOH or other alkaline salt, which may improve performance of reversible device 310. By combining the water and oxygen in the oxygen electrode, local relative humidity may be fixed at 100% due to the presence of excess liquid water. It is noted that while water consumption in the electrolyzer mode and water production in the fuel cell mode of reversible device 310 balance each other, some addition of water may be required due to system losses. A balance between oxygen and water supply may be controlled by controller 301 to optimize fuel cell performance, e.g., by using pure oxygen, and/or hydrophobizing or partially hydrophobizing the oxygen side catalyst layer and/or diffusion medium in membrane assembly 100, to preserve some areas free or partially free of liquid water and thereby allowing good access of the reactant oxygen to the catalyst surface. Water or dilute electrolyte may be stored in liquid/gas separation tank 344 or in an additional tank. A water supply line may optionally be included in system 300 to assure that the water supply is not depleted. In both power generation and hydrogen generation modes, the water continues to function as the temperature controlling fluid, and is still passed through the radiator to dissipate excess heat generated by either device.

Advantageously, by capturing the water generated in the fuel cell mode and the oxygen (in addition to the hydrogen) generated in the electrolyzer mode, system 300 may be entirely self-contained without need of any external supply of hydrogen, water or air/oxygen, needing only external power input 326 for refueling (hydrogen generation in the electrolyzer mode), thus retaining one of the key benefits of battery-based power systems while allowing a conceptually unlimited amount of energy capacity without the need for a larger device, a capability unavailable to battery systems.

Self-refueling power-generating system 300 further comprises a power connection unit 320 configured to receive power from reversible device 310 when operated in the fuel cell mode, e.g., as power output 325; and to deliver power to reversible device 310 when operated in an electrolyzer mode, e.g., as power input 326. Power connection unit 320 may be configured to deliver the received power to an external load when required, and to receive power for delivery from an external source when available. In various embodiments, power input 326 may be received from various sources, such as an electric grid, renewable energy resources and/or batteries, possibly selected according to their respective time-dependent cost and availability. For example, power input 326 may be selected from solar panels or wind turbines when these are available. Self-refueling power-generating system 300 may be used as any of a backup electrical power generation system, portable power generation system or any other power generation system that is entirely independent of normal user intervention for refueling operations, but rather self-recharges whenever the fuel storage unit is not full and an external electrical power supply is available. Certain embodiments comprise a grid setup comprising a plurality of independent systems 300, that may use separate or shared hydrogen fuel storage 352, and optional oxygen storage 332, optional battery banks, and power sources 326 to provide a localized independent power supply solution to the users of that grid.

FIG. 8 is a high-level flowchart illustrating a method 450 of configuring a power-generating system to be self-refueling and self-sustaining, according to some embodiments of the invention. The method stages may be carried out with respect to system 300 and reversible device 310 described above, which may optionally be configured to implement method 450. Method 450 may be at least partially implemented by at least one computer processor, e.g., in a power-generating system the comprises a reversible device comprising (i) a stack of electrochemical cells with respective membrane assemblies, the device configured to be operated alternately as a fuel cell in a fuel cell mode and as an electrolyzer in an electrolyzer mode, wherein each of the membrane assemblies has a hydrogen-side catalyst layer configured to catalyze hydrogen oxidation in the fuel cell mode and to catalyze hydrogen formation in the electrolyzer mode and an oxidant-side catalyst layer configured to catalyze oxygen reduction in the fuel cell mode and to catalyze oxygen formation in the electrolyzer mode, the catalyst layers being separated by a separation layer, (ii) a hydrogen unit configured to supply hydrogen to the reversible device when operated in the fuel cell mode, and receive and optionally compress hydrogen from the reversible device when operated in the electrolyzer mode, and (iii) a power connection configured to receive power from the reversible device when operated in the fuel cell mode, and deliver power to the reversible device when operated in the electrolyzer mode, wherein the power connection is configured to deliver the received power to an external load when required, and to receive power for delivery from an external source when available. Certain embodiments comprise computer program products comprising a computer readable storage medium having computer readable program embodied therewith and configured to carry out any of the relevant stages of method 450. Method 450 may comprise the following stages, irrespective of their order.

Method 450 may comprise determining operation of the reversible device in the fuel cell mode or in the electrolyzer mode according to power requirements and power availability (stage 401), e.g., using artificial intelligence or machine learning algorithms and taking into account predetermined expected use cases, specific customer needs, time-criticality in increasing the available stored hydrogen, as well as power cost, source and availability.

In various embodiments, method 450 may further comprise any of: optimizing the hydrogen-side catalyst layer and the oxidant-side catalyst layer to operate in both the fuel cell mode and the electrolyzer mode according to specified requirements (stage 252), configuring the membrane assemblies to have the catalyst layers and the separation layer embedded in continuous polymerized ionomer material (stage 254), configuring the separation layer to comprise at least one layer that includes surface-charged particles that have a surface excess of charges, imparting ion conductivity along that surface when hydrated (stage 256), e.g., with the surface-charged particles comprising at least one of: charged clay particles, charged ceramic particles, graphene oxide particles, reduced or partially reduced graphene oxide particles and surface-charged polymer particles; and/or configuring the separation layer to have at least one protective layer adjacent to a respective one of the catalyst layers, to prevent dehydration thereof and/or exposure thereof to excessively oxidating and/or reducing conditions (stage 258).

Method 450 further comprises supplying oxygen to the reversible device in a closed circuit, by supplying oxygen to the reversible device when operated in the fuel cell mode, and receiving and compressing oxygen from the reversible device when operated in the electrolyzer mode (stage 460), and supplying water or dilute electrolyte to the reversible device in a closed circuit, by supplying and receiving water or dilute electrolyte in conjunction with the closed oxygen supply circuit by separating oxygen produced by the reversible device in the electrolyzer stage from the water or dilute electrolyte received from the reversible device (stage 470).

Advantageously, in use examples such as backup power scenarios, the most common operations would be to use a small portion of the available hydrogen. Given a reasonably predictable frequency of power outages, system 300 and method 450 may automatically run electrolysis at close to maximum efficiency and minimum refueling rate, and still expect the tanks to be full before the next outage. In use examples where power availability may be critical, the algorithm may be optimized to refuel to some minimum critical amount of fuel at the maximum available rate, then run at maximum efficiency for the remaining refueling process. In use examples where cost of power supplied to the system for electrolysis is critical, system 300 may be configured to operate at maximum electrolysis efficiency. In examples use where system 300 is to be used next at a known future time, for example in some cases for portable power generation devices, the electrolysis operation could be fixed to a rate that delivers full tanks by an acceptable time ahead of the known next use.

FIG. 9 is a high-level schematic illustration of the operation of AEM and PEM reversible devices 310 in fuel cell mode 90A and in electrolyzer mode 90B, according to some embodiments of the invention. Disclosed membrane assemblies 100 and separation layer(s) 30 may be used for operation fuel cell mode 90A and in electrolyzer mode 90B, for which the principles of operation are briefly described. As non-limiting examples, implementations of fuel cell mode 90A and electrolyzer mode 90B with AEM (anion exchange membranes) and PEM (proton exchange membranes) are illustrated in a highly schematic manner. Each membrane assembly 100 in the stack of electrochemical cells typically has catalyst layers 130, 140 with corresponding catalysts that catalyze the respective reactions, as described briefly herein. In reversible devices 310 as disclosed herein, catalyst layers (electrodes) 130, 140 switch functions upon changing from fuel cell mode 90A to electrolyzer mode 90B, as explained below, e.g., anodes 130 in fuel cell mode 90A function as cathodes 130 in electrolyzer mode 90B and cathodes 140 in fuel cell mode 90A function as anodes 140 in electrolyzer mode 90B.

In fuel cell mode 90A, the electrochemical cells generate electricity (denoted schematically as “electricity out”) using a fuel (e.g., hydrogen) and an oxidizing agent (e.g., oxygen). In the case of hydrogen AEM fuel cell mode 90A, the hydrogen fuel is oxidized by hydroxide (OH⁻) anions formed at cathodic oxidant-side catalyst layer 140 from a reaction of water with oxygen, and moving through separation layer(s) 30 to anodic hydrogen-side catalyst layer 130, releasing electrons that travel through an external circuit to the cathode, thereby providing electrical power, as well as product water. In hydrogen PEM fuel cell mode 90A, the hydrogen is oxidized at anodic hydrogen-side catalyst layer 130, releasing electrons that travel through an external circuit to cathodic oxidant-side catalyst layer 140, thereby providing electrical power, and protons which move through separation layer(s) 30 to cathodic oxidant-side catalyst layer 140 where they combine with oxygen to form product water.

In electrolyzer mode 90B, the electrochemical cells use electricity (denoted schematically as “electricity in”) to break down compounds (e.g., water) to yield products (e.g., hydrogen or other compounds). In AEM water electrolyzer mode 90B (including ones working with alkaline water, e.g., water with KOH), electricity is used to break down water to form hydrogen gas at cathodic hydrogen-side catalyst layer 130, as well as hydroxide (OH⁻) anions that move through separation layer(s) 30 to anodic oxidant-side catalyst layer 140, where they are reacted to form oxygen and water. In PEM electrolyzer mode 90B, water is broken down at anodic oxidant-side catalyst layer 140 to yield oxygen gas and cations (e.g., protons) that move through separation layer(s) 30 to form hydrogen gas at cathodic hydrogen-side catalyst layer 130.

Electrolyzer mode 90B is typically used to generate hydrogen for storage a future use, e.g., in fuel cell mode 90A. Reversible devices 310 may be optimized to operate alternatively, or alternately, in fuel cell mode 90A and in electrolyzer mode 90B. Reversible devices 310 may further comprise gas diffusion layers (GDLs) that allow gases and/or fluids through. Membrane assemblies 100 may comprise separation layer(s) 30, optionally one or both catalyst layers (electrodes) 130, 140 and optionally also corresponding gas diffusion layers. For example, membrane assemblies 100 may be configured to operate as membrane-electrode assemblies (MEAs) that are the core components of proton-exchange membrane fuel cells (PEMFCs) and proton-exchange membrane electrolyzers (PEMELs); as well as of anion-exchange membrane fuel cells (AEMFCs) and anion-exchange membrane electrolyzers (AEMELs). Membrane assemblies 100 may be manufactured separately from the electrodes, or one or even both electrodes 130, 140 may be deposited on membrane assembly 100 itself, forming respective catalyst-coated membranes (CCM). Alternatively or complementarily, the catalyst layers may be deposited on gas-diffusion layers (GDLs), forming gas diffusion electrodes (GDEs) that are pressed against membrane assembly 100 to form the respective stacks.

Reversible AEM/PEM devices 310 may be operated as either fuel cells 90A and/or electrolyzers 90B, depending on their operation conditions and material and energy flows. Power flow, and flows of hydrogen, oxygen and water may be reversed upon switching the operation mode of reversible AEM/PEM devices 310 and layer properties of reversible AEM/PEM devices 310 may be selected to operate effectively in both modes, as disclosed herein.

Separation layer(s) 30 may comprise one or more sheet(s) that may range in thickness from a few μm, through tens of μm and up to one or two hundred μm. Separation layer(s) 30 may comprise multiple thin sheets, some thin and some thicker sheets, or any operable combination of number and thickness of the sheets, reaching an overall thickness of up to 200 μm. The sheets of separation layer(s) 30 may be configured to combine high ionic conductivity, water transportability, mechanical strength and stability, and low gas permeation, and be optimized respectively as disclosed herein. For example, one or more sheets of separation layer(s) 30 may be configured to support other, main separation sheet(s) of separation layer(s) 30. The supporting sheets in separation layer(s) 30 may be very thin, e.g., hundreds of nanometers thick, tens of nm thick or even 10 nm, 5 nm or less in thickness, possibly down to the thickness of ceramic particles embedded therein themselves.

In various embodiments, separation layer(s) 30 may comprise ionomer membranes, membranes that incorporate ionic particles, and/or stabilizing structures such as mesh supports or particles, which may also limit membrane swelling upon water uptake. The thickness and order of multiple separation layers 30 may be configured to optimize the parameters required for each type of operation mode and respective performance requirements. Membrane assemblies 100 may include several functional separation layers 30, and may be manufactured in different ways, e.g., by multi-layer deposition upon any substrate (including e.g., GDL(s), GDE(s), catalyst layers as CCMs, etc.) or by attaching of multiple supported and/or unsupported layers of separation layer(s) 30, as disclosed herein.

Separation layer(s) 30 are configured to provide a gas-tight separation between electrodes 130, 140 and to conduct ions and transfer water between electrodes 130, 140. Separation layer(s) 30 are configured to have high ionic conductance (e.g., larger than any of 5 S·cm⁻², 10 S·cm⁻², 20 S·cm⁻², 50 S·cm⁻², 100 S·m⁻², or intermediate values, when hydrated) to limit ohmic losses and high water permeance to limit device dry-out, e.g., by using high quality ionomers and/or by decreasing membrane thickness—either by reaching the limit for ultra-thin freestanding membranes or by using membranes supported by meshes, which however reduce the amount of available ionomer, yielding a tradeoff between the components contributing to ionic conductivity. It is noted that the conductance is the reciprocal of the area-specific resistance (ASR) of a layer such as a sheet or a membrane, and has units of S/cm². The conductance is a function of the layer's conductivity (which is a material property having units of S/cm), normalized by the thickness of that layer. For example, a 0.01 cm (100 μm) thick layer made of a material or composite with ion conductivity of 100 mS/cm, has a conductance of 10 S/cm² (100 mS/cm divided by 0.01 cm), and accordingly that layer has an ASR of 0.1 Ω·cm²). Disclosed separation layer(s) 30 and membrane assemblies 100 are characterized by a combination of high ionic conductivity, high mechanical strength, and low gas crossover.

Membrane assemblies 100 may be designed to optimize the performance of reversible devices 310 by adjusting the architecture of the electrodes to support the respective electrochemical and physical processes. For example, membrane assemblies 100 may be configured to assure percolation through the ionomer-rich phase to ensure ionic transport through membrane assembly 100 as a whole. Membrane assemblies 100 may further be configured to manage water transport within the ionomer, and to form, by configuration of the catalyst and support particles, a percolation network that provides electronic conductivity. Membrane assemblies 100 may further be configured to locate the catalyst particles accurately at the ionomer-pore interfaces, forming a three-phase interface, to support the catalytic processes (e.g., avoiding fully covering catalyst particles by ionomer and setting the catalyst particles close to the ionomer phase). Membrane assemblies 100 may be porous in order to provide a path for the gas reactants.

It is noted that in the following, each of catalyst layers 130, 140 may comprise either of catalyst layers 22, 24, and may be understood in a general sense to include supporting GDLs 12, 14 so that catalyst layers 130, 140 represent in FIGS. 7-9 whole GDEs 110, 120. Clearly, either of catalyst layers 130, 140 may refer to one or the other of GDEs 110, 120 or their corresponding catalyst layers 22, 24, with the other one of catalyst layers 130, 140 referring to other one of GDEs 110, 120 or their corresponding other catalyst layers 22, 24. Similarly, the GDLs may correspond to GDLs 12, 14, in any order. In certain embodiments, first catalyst layer 22 may be a hydrogen-side catalyst layer configured to catalyze hydrogen oxidation and/or hydrogen formation and used to form HER/HOR electrode 130, and second catalyst layer 24 may comprise an oxidant-side catalyst layer configured to catalyze oxygen reduction and/or oxygen formation, and used to form OER/ORR electrode 140, as disclosed below. In any of the embodiments, while not explicitly illustrated, thin membrane 30 may be deposited on either or both HER/HOR electrode 130 and/or OER/ORR electrode 140.

FIG. 10A is a high-level schematic block diagram of an electrolyzer 312, according to some embodiments of the invention. Electrolyzer 312 comprises GDE 130 as HER made of the GDL with the applied mixture of catalyst dispersion and binder dispersion (e.g., comprising Teflon)—hot pressed thereupon, and further comprising a catalyst-coated porous transfer layer as an oxygen evolution reaction (OER) electrode 140 and electrolyte 190. In certain embodiments, OER electrode 140 with metal-based GDL may likewise include binder material and be hot-pressed. Electrolyte 190 may be alkaline and comprise e.g., KOH, K₂CO₃ and/or KHCO₃ solutions at concentrations up to 10M (e.g., 0.01M, 0.1M, 1M, 1-5M, 3-10M or intermediate values) or may possibly comprise water (with ionomer material combined in the catalytic layer providing ionic conductivity).

The binder material may be selected to enhance the stability and the durability of the electrode, particularly when hot pressed. Binder materials may comprise one or more materials, which have (i) low glass transition temperatures (e.g., Tg<180° C.), (ii) low swelling properties (e.g., less than 80% swelling in X-Y direction in wet conditions, at 80° C. , OH— form)—to make the respective electrode mechanically stable, (iii) sufficient chemical stability at alkaline conditions (e.g., 1M KOH), (iv) prolonged thermal stability, e.g., being stable above 100° C. for at least 1000 h. Specific examples for alternative binders include chlorotrifluoroethylene, perfluoroalkoxy alkane (PFA), ethylene tetrafluoroethylene, polyvinylidene fluoride or poly (methyl-methacrylate) or any combination of these materials. In any of the disclosed embodiments, the binder material may comprise Teflon and/or any binder(s) which conform to these requirements. In any of the embodiments in which Teflon is used, Teflon may be partly or fully replaced by other types of appropriate binders.

In any of the disclosed embodiments, hot pressing may be optimized with respect to the type of binder and with respect to other GDE components—to yield the most stable and most efficient electrode, depending on performance requirements. For example, hot pressing may be carried out within the temperature range of 80-180° C. (depending on the Tg of the selected binder as well as on the type of ionomer and other electrode materials) and carried out for the ranges of few seconds to a few minutes (e.g., between ten seconds and ten minutes).

In non-limiting examples, a mixture of catalyst (e.g., Pt) dispersion in a solvent (e.g., 2-propanol and DI (deionized) water) and binder (e.g., Teflon) dispersion in water may be applied (e.g., sonicated and sprayed) on the GDL, which may then be pressed between plates to form GDE 130. OER electrode 140 may comprise catalyst (e.g., Ni) dispersion in the solvent (e.g., 2-propanol and DI water), applied (e.g., sonicated and sprayed) on a Ni PTL (porous transport layer). In certain embodiments, OER electrode 140 may be produced as a PTL, using binder dispersion and hot pressing, e.g., with respective catalysts/binders coated on the metal-based PTL and hot pressing for OER electrode 140. OER electrode 140 may further comprise ionomer material, or comprise catalyst and binder material (e.g., Teflon) without additional ionomer.

FIG. 10B is a high-level schematic block diagram of a fuel cell 311, according to some embodiments of the invention. Fuel cell 311 comprises GDE 140 as ORR made of the GDL with the applied mixture of catalyst dispersion, ionomer and binder (e.g., Teflon) dispersion hot pressed thereupon, and further comprising a hydrogen oxidation reaction (HOR) electrode 124. For example, HOR electrode 130 may comprises a catalyst (e.g., Pt) dispersion and ionomer, applied (e.g., sonicated and sprayed) on a HOR GDL. The ionomer material may provide ionic conductivity, without requiring electrolyte solution in fuel cell 311.

In non-limiting examples, a mixture of catalyst (e.g., Ag) dispersion in solvent (e.g., 2-propanol and DI water), ionomer and binder (e.g., Teflon) dispersion in water may be applied (e.g., sonicated and sprayed) on the GDL, which may then be pressed between plates, for example stainless steel plates or other types of plates, to form GDE 140. HOR electrode 130 may comprise catalyst dispersion in solvent (e.g., 2-propanol and DI water) mixed with ionomer and applied (e.g., sonicated and sprayed) on a GDL.

In various embodiments, the solvent(s) may comprise, e.g., any of water, 2-propanol, ethanol, methanol, N-methyl-2-pyrrolidone, toluene, tetra-hydro-furan and/or combinations thereof with different ratios. Any of the dispersions may be formulated as an ink for the corresponding form of application.

In certain embodiments, GDEs (with carbon-based GDLs) may be used in fuel cells 311 both as ORR electrode 140 and as HOR electrode 124, with corresponding adjustments.

FIG. 10C is a high-level schematic block diagram of a dual cell 310, according to some embodiments of the invention. Dual cell 310 may be reversible, configured to operate alternately (and reversibly) as electrolyzer 312 and fuel cell 311, depending on the operation conditions of dual cell 310, namely whether electricity is provided to dual cell 310 to generate hydrogen and oxygen by electrolysis (and be operated as electrolyzer 312, with electrolyte 190 comprising water or an alkaline solution) or whether hydrogen and oxygen are delivered to dual cell 310 to generate electricity (and be operated as fuel cell 311). Correspondingly, both GDEs, namely HER/HOR electrode 130 and OER/ORR electrode 140, may be produced as disclosed herein, by spraying catalyst dispersion, binder (e.g., Teflon) and ionomer material of respective GDLs and hot pressing them to form the respective GDEs. Clearly the exact details of the catalyst type, binder (e.g., Teflon) concentration and ionomer type and concentration may be optimized to provide the required ionic conductivity and electrode stability, e.g., from the options disclosed herein, with respect to specific assembly and operation parameters of dual cell 310. In certain embodiments, OER/ORR electrode 140 may be produced as a PTL, using binder dispersion and hot pressing, e.g., with respective catalysts/binders coated on the metal-based PTL and hot pressing for OER/ORR electrode 140. OER/ORR electrode 140 may further comprise ionomer material, or comprise catalyst and binder material (e.g., Teflon) without additional ionomer.

In certain embodiments, any of fuel cell 311, electrolyzer 312 and/or dual cell 310 may comprise free-standing membrane 35 (see FIG. 1), set between first and second GDEs 110, 120. The free-standing membrane may comprise the same or different composition and material properties as the membrane component(s) coated on GDE's. It may be between 5 and 200 microns thick, and have a conductivity between 5 mS/cm and 200 mS/cm or more.

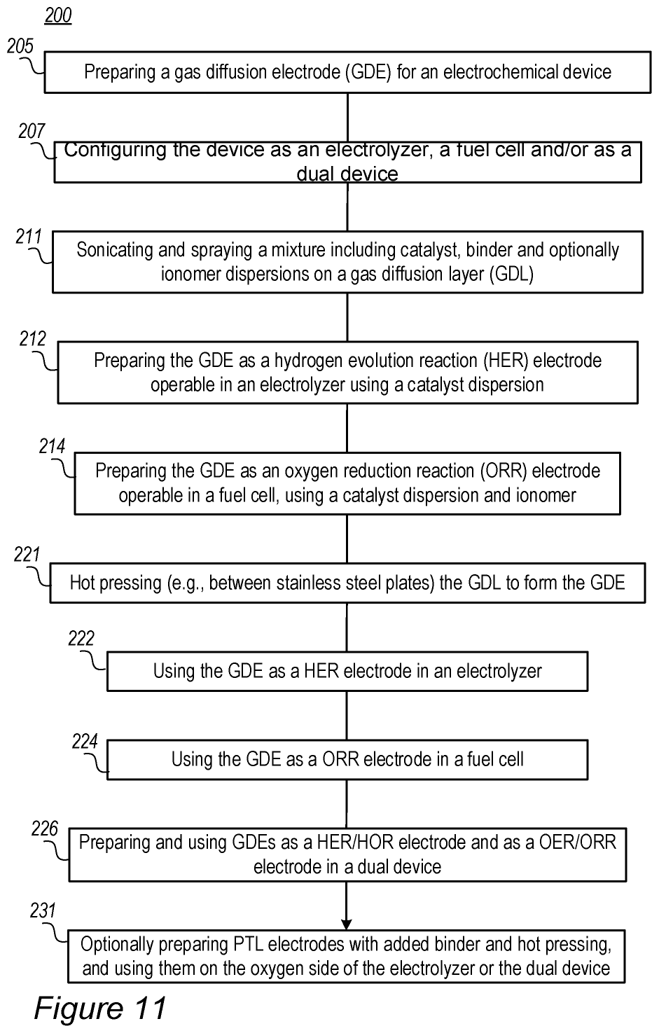

FIG. 11 is a high-level flowchart illustrating a method 200, according to some embodiments of the invention. The method stages may be carried out with respect to the disclosed GDE electrodes, electrolyzer 312 and/or fuel cells 311 described above, which may optionally be configured to implement method 200. Method 200 may comprise the following stages, irrespective of their order.

Method 200 may comprise preparing a gas diffusion electrode (GDE) for an electrochemical device (stage 205), the method comprising: sonicating and spraying a mixture on a gas diffusion layer (GDL), wherein the mixture comprises a catalyst dispersion and a binder dispersion (stage 211), and hot pressing the GDL to form the GDE (stage 221), for example at the glass transition temperature of the binder, and e.g., between plates.

In certain embodiments, method 200 may comprise preparing the GDE using a catalyst dispersion (stage 212), e.g., Pt, and using the GDE as a hydrogen evolution reaction (HER) electrode operable in an electrolyzer (stage 222), e.g., with a catalyst-coated porous transport layer (PTL) as an OER electrode and KOH electrolyte.

In certain embodiments, method 200 may comprise preparing the GDE using a catalyst (e.g., Ag) dispersion and ionomer (stage 214) and using the GDE as an oxygen reduction reaction (ORR) electrode operable in a fuel cell (stage 224), e.g., with a catalyst (e.g., Pt) dispersion and ionomer, sonicated and sprayed on a HOR GDL and KOH electrolyte.

In certain embodiments, method 200 may comprise configuring the device as an electrolyzer, fuel cell and/or a dual device (stage 207), with respective GDEs as ORR electrodes for fuel cells, HER electrodes for electrolyzers and/or preparing and using GDEs as a HER/HOR electrode and as a OER/ORR electrode in a dual device (stage 226). Method 200 may thus comprise using the GDEs to form a dual cell, that is operable alternately as an electrolyzer and as a fuel cell (with both GDEs including ionomer).

In various embodiments, disclosed uses of binder and hot pressing may be applied to one or both types of electrodes in each type of device. For example, in fuel cells, only ORR electrode or both ORR and HOR electrodes may be produced using binder dispersion and hot pressing, e.g., with respective catalysts/binders coated on respective carbon-based GDLs. In electrolyzers, only HER electrode or both HER and OER electrodes may be produced using binder dispersion and hot pressing, e.g., with respective catalysts/binders coated on carbon-based GDL for the HER electrode and on metal-based PTL for the OER electrode. In dual systems, the OER/ORR (on metal-based PTL) electrodes and the HER/HOR (on carbon-based GDL) electrodes may be produced using binder dispersion and hot pressing as disclosed herein. Specifically, in certain embodiments, PTL electrodes may be prepared with added binder and hot pressing, and be used on the oxygen side of the electrolyzer or the dual device (stage 231).

In various embodiments, catalyst dispersion for either electrode may include other types of catalysts, such as other members of the platinum group metals (PGMs), non-supported or supported on carbon. For example, the hydrogen-side catalyst layer may include ionomer(s) with embedded hydrogen oxidizing and/or hydrogen evolving (generating) catalyst particles such as nanoparticles made of any of Pt, Ir, Pd, Ru, Ni, Co, Fe, Pd—CeO_{X} and their alloys, blends and/or combinations, optionally supported on carbon or other conducting substrates. Alternatively or complementarily, the hydrogen-side catalyst layer may comprise modified carbons with embedded catalytic groups such as nitrides or various transition metals. Alternatively or complementarily, the hydrogen-side catalyst layer may comprise transition metal oxides or hydroxides based on Ni, Co, Mn, Mo, Fe, etc., nitrogen-doped and/or metal-doped carbon materials. The hydrogen-side catalyst layer may have an ionomer content of between 0% to 40% w/w (or within subranges such as 0% to 10% w/w, 5% to 20% w/w, 10% to 30% w/w, 20% to 40% w/w, or other intermediate ranges). The hydrogen-side catalyst layer may be configured to be stable over the full voltage range of electrode operation, e.g., from under about −0.2 V in electrolyzer mode to over about +0.4V in fuel cell mode, versus a reversing hydrogen electrode. In non-limiting examples, the oxygen-side catalyst layer may include ionomer(s) with embedded cathode catalyst particles such as nanoparticles made of oxygen reducing and/or oxygen evolving (generating) catalysts made of any of NiFe₂O₄, Perovskites, Fe, Zn, Ag, Ag alloyed with Pt, Pd, Cu, Zr, Ag, Ni, Fe, Mn, Co, Pt, Ir, Ru their alloys, blends and/or combinations, possibly combined with metal oxides such as, e.g., cerium oxide, zirconium oxide, their alloys, blends and/or combinations. Alternatively or complementarily, the oxygen-side catalyst layer may comprise the metal particles in oxide or hydroxide form and/or include surface oxide or hydroxide layers. Alternatively or complementarily, the oxygen-side catalyst layer may comprise transition metal(s), metal oxide(s) and/or metal hydroxide(s) that are based on Ni, Fe, Co, Mn, Mo and their alloys, mixed oxides or mixed hydroxides such as spinel, perovskite or layered double hydroxide (LDH) structures, potentially doped with or loaded with Pt, Ir, Ru, Ag or other elements to enhance oxygen generation and/or reduction performance.

Gas diffusion layer(s) (GDLs) and/or may include any type of gas diffusion layers such as carbon paper, non-woven carbon felt, woven carbon cloth and the like, nickel, titanium or stainless steel meshes, felts, foams, sintered microspheres, or other porous and electrically conductive substrates. In some embodiments, the GDLs may be attached to a microporous layer (MPL), made, e.g., from sintered carbon and/or optionally polytetrafluoroethylene (PTFE) or other hydrophobic particles, or from various porous metallic or other porous conductive layers.

In various embodiments, the PTL (porous transport layer) may be made of the following materials: Ni, various grades of stainless steel, titanium or any combination of all of them together. In addition, it can be either felt, mesh, or dual layers, with different porosity values and different thicknesses. The PTL may be used with or without a mesoporous layer (MPL).

In non-limiting examples of AEM and/or PEM implementations, the ionomeric material matrix may comprise respective materials as described herein for respective AEM/PEM ionomeric material matrix 110.

Non-limiting examples and experimental results are provided in the following. In these examples, the combination of using Teflon material and brief hot-pressing was used to enhance the performance of the respective electrodes with respect to their stability and durability. GDEs with 5 cm² active area were prepared and tested in respective sealed electrolyzer and fuel cell configurations.

In the electrolyzer configurations, catalyst dispersion was applied to yield a loading of 0.17 mg/cm² on the HER GDE. The Teflon dispersion had a 60% wt % and 1.5 gr/ml density (in water) with particle size between 0.05-0.5 μm. Mixtures with Teflon content ranging between 3 wt %, 6 wt % and 10 wt % were compared. The mixture was sonicated for 15 minutes and sprayed by a spray gun on Freudenberg carbon paper GDLs, and then hot-pressed at 119° C. to change the Teflon to amorphous structure near its Tg (glass transition temperature). The Ni PTL OER electrode was prepared in a similar manner of spraying, without using Teflon, ionomer or applying hot pressing. The electrolyzer cells were assembled using Ni200 flow fields, stainless steel end plates, 50 μm PTFE sub-gaskets and 250/311 μm thick PTFE gaskets at the cathode/anode sides, respectively, sealed under a torque of 7 Nm.

In the fuel cell configurations, the catalyst dispersion was applied to yield a loading of 2.5 mg/cm² on the ORR GDE, with a 4 wt % commercial ionomer. The Teflon dispersion had a 60% wt % and 1.5 gr/ml density (in water) with particle size between 0.05-0.5 μm and an overall Teflon content of 3 wt %. The HOR electrode was prepared in a similar manner of spraying a mixture of catalyst dispersion applied to yield a loading of 1.4 mg/cm² and including 12 wt % commercial ionomer. Both mixtures were sonicated for 15 minutes and sprayed by a spray gun on Freudenberg nonwoven carbon GDLs with microporous layer. The ORR GDE was hot-pressed at 119° C. for 3 minutes at a pressure of 106 kg/cm², to change the Teflon to amorphous structure at its Tg (glass transition temperature). The fuel cells were assembled and sealed using 200 μm thick Kapton polyimide gaskets on both electrodes, under a torque of 7 Nm.

Specific examples and implementations are described in Israeli Patent No. 282438, and in WIPO Publication No. 2022157777, and are incorporated herein by reference in their entirety.

Elements from FIGS. 1-11 may be combined in any operable combination, and the illustration of certain elements in certain figures and not in others merely serves an explanatory purpose and is non-limiting.

Advantageously, disclosed embodiments include catalyst coated GDEs, rather than prior art catalyst coated membranes (CCMs). It is further noted that some of the disclosed embodiments refer to alkaline anion exchange membranes (AEM) rather than to proton exchange membranes (PEMs) taught by prior art such as U.S. Pat. No. 6,946,210. AS shown but studies such as Ashdot et al. 2021 (Design strategies for alkaline exchange membrane—electrode assemblies: optimization for fuel cells and electrolyzers, Membranes 11, 686), catalyst coated GDEs are fundamentally different from CCMs in their physical properties of attachment, the resulting stack structure and in the advantages and disadvantages with respect to their performance within the electrochemical device.

In the above description, an embodiment is an example or implementation of the invention. The various appearances of “one embodiment”, “an embodiment”, “certain embodiments” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A membrane electrode assembly (MEA) for an electrochemical device, the MEA comprising:
a first gas diffusion electrode (GDE) comprising a first gas diffusion layer (GDL) coated with a first catalyst layer,
a second GDE comprising a second GDL coated with a second catalyst layer,
a thin membrane coated on the first catalyst layer of the first GDE and/or on the second catalyst layer of the second GDE, wherein a total thickness of the thin membrane is at most 30 microns,
wherein the first and the second GDEs are joined together to form the MEA with the thin membrane located between the first and the second catalyst layers, and
a seal configured to seal the MEA.

2. The MEA of claim 1, wherein the jointing together is carried out over a joined area which is pressed mechanically and/or crosslinked chemically.

3. The MEA of claim 1, wherein the first and/or the second GDL comprises a microporous layer.

4. The MEA of claim 1, wherein a first portion of the thin membrane is coated on the first catalyst layer and a second portion of the thin membrane is coated on the second catalyst layer, and wherein the joined area joins the first and second portions of the thin membrane.

5. The MEA of claim 1, wherein the seal includes an infused sealing material and/or gaskets, and seals all sides of the joined first and second GDEs.

6. The MEA of claim 1, wherein the thin membrane comprises ionomer and reinforcing nanoparticles.

7. The MEA of claim 1, further comprising a free-standing membrane between the first and the second GDEs.

8. The MEA of claim 1, wherein the first catalyst layer is a hydrogen-side catalyst layer configured to catalyze hydrogen oxidation and/or hydrogen formation, and the second catalyst layer is an oxidant-side catalyst layer configured to catalyze oxygen reduction and/or oxygen formation.

9. A stack of multiple MEAs of claim 8, wherein each of the MEAs is sealed independently of the sealing of the other MEAs in the stack.

10. A fuel cell comprising the stack of the MEAs of claim 9, wherein the hydrogen-side catalyst layer is configured to catalyze hydrogen oxidation, and the oxidant-side catalyst layer is configured to catalyze oxygen reduction.

11. An electrolyzer comprising the stack of the MEAs of claim 9, wherein the hydrogen-side catalyst layer is configured to catalyze hydrogen formation, and the oxidant-side catalyst layer is configured to catalyze oxygen formation.

12. A reversible device comprising the stack of the MEAs of claim 9, the reversible device configured to operate alternately as a fuel cell in a fuel cell mode and as an electrolyzer in an electrolyzer mode, wherein the hydrogen-side catalyst layer of the MEAs is configured to catalyze hydrogen oxidation in the fuel cell mode and to catalyze hydrogen formation in the electrolyzer mode, and the oxidant-side catalyst layer of the MEAs is configured to catalyze oxygen reduction in the fuel cell mode and to catalyze oxygen formation in the electrolyzer mode.

13. A self-refueling power-generating system comprising:
the reversible device of claim 9,
a controller configured to determine operation of the reversible device in the fuel cell mode or in the electrolyzer mode,
a hydrogen unit configured to supply hydrogen to the reversible device when operated in the fuel cell mode, and receive and optionally compress hydrogen from the reversible device when operated in the electrolyzer mode,
an oxidant unit configured to supply oxygen to the reversible device when operated in the fuel cell mode, and receive and optionally compress oxygen from the reversible device when operated in the electrolyzer mode,
a water unit configured to supply water or dilute electrolyte to the reversible device in a closed circuit and in conjunction with the supply of oxygen thereto, wherein the water unit comprises a gas/liquid separation module configured to deliver separated oxygen from the reversible device to the oxidant unit, and
a power connection configured to receive power from the reversible device when operated in the fuel cell mode, and deliver power to the reversible device when operated in the electrolyzer mode, wherein the power connection is configured to deliver the received power to an external load when required, and to receive power for delivery from an external source when available.

14. The self-refueling power-generating system of claim 13, wherein the reversible device further comprises a free-standing membrane between the first and the second GDEs.

15. The self-refueling power-generating system of claim 13, wherein the hydrogen unit is further configured to compress hydrogen from the reversible device when operated in the electrolyzer mode, and/or the oxidant unit is further configured to compress oxygen from the reversible device when operated in the electrolyzer mode.

16. The self-refueling power-generating system of claim 13, wherein the water is supplied to and removed from the oxygen-side catalyst layer, together with the oxygen.

17. The self-refueling power-generating system of claim 13, wherein the water unit is further configured collect and reuse water or dilute electrolyte during the operation in the electrolyzer mode, and the system is self-sustained, using no external resource for water, oxygen or hydrogen.

18. A membrane electrode assembly (MEA) for an electrochemical device, the MEA comprising:
a first gas diffusion electrode (GDE) comprising a first gas diffusion layer (GDL) optionally coated with a first catalyst layer,
a second GDE comprising a second GDL optionally coated with a second catalyst layer,
wherein at least one of the GDEs is coated by the corresponding catalyst layer,
a thin membrane coated on the first catalyst layer of the first GDE and/or on the second catalyst layer of the second GDE, wherein a total thickness of the thin membrane is at most 30 microns,
a free-standing thin membrane having a total thickness below 30 microns,
wherein the first and the second GDEs are joined together to form the MEA with the free-standing thin membrane located between the GDEs, and
a seal configured to seal the MEA.

19. An electrochemical device comprising a stack of multiple MEAs of claim 18, wherein each of the MEAs is sealed independently of the sealing of the other MEAs in the stack, wherein the electrochemical device comprises at least one of a fuel cell, an electrolyzer and/or a reversible device configured to operate alternately as a fuel cell in a fuel cell mode and as an electrolyzer in an electrolyzer mode.

20. A self-refueling power-generating system comprising:
the electrochemical device of claim 19, configured as a reversible device wherein the hydrogen-side catalyst layer of the MEAs is configured to catalyze hydrogen oxidation in the fuel cell mode and to catalyze hydrogen formation in the electrolyzer mode, and the oxidant-side catalyst layer of the MEAs is configured to catalyze oxygen reduction in the fuel cell mode and to catalyze oxygen formation in the electrolyzer mode,
a controller configured to determine operation of the reversible device in the fuel cell mode or in the electrolyzer mode,
a hydrogen unit configured to supply hydrogen to the reversible device when operated in the fuel cell mode, and receive and optionally compress hydrogen from the reversible device when operated in the electrolyzer mode,
an oxidant unit configured to supply oxygen to the reversible device when operated in the fuel cell mode, and receive and optionally compress oxygen from the reversible device when operated in the electrolyzer mode,
a water unit configured to supply water or dilute electrolyte to the reversible device in a closed circuit and in conjunction with the supply of oxygen thereto, wherein the water unit comprises a gas/liquid separation module configured to deliver separated oxygen from the reversible device to the oxidant unit, and
a power connection configured to receive power from the reversible device when operated in the fuel cell mode, and deliver power to the reversible device when operated in the electrolyzer mode, wherein the power connection is configured to deliver the received power to an external load when required, and to receive power for delivery from an external source when available.
